(19) United States
(12) Patent Application Publication
(10) Pub. No.: US 2009/0325813 A1
(43) Pub. Date: Dec. 31, 2009

(54) Methods and kits for quantitative oligonucleotide analysis

(76) Inventors: Hui Wang, Cupertino, CA (US); Bo U. Curry, Redwood City, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/215,302

(22) Filed: Jun. 26, 2008

(51) Int. Cl. C40B 30/04; C40B 40/06

(52) U.S. Cl. 506/9; 506/16

(57) ABSTRACT

Aspects of the disclosure are generally directed to methods, probes, probe compositions and kits for detecting or quantifying target oligonucleotides. In some embodiments, there are provided methods for determining the level of target oligonucleotides, such as a small RNA (e.g., miRNA), in a sample. In some embodiments, the methods comprise analyzing hybridization of target oligonucleotides to a test microarray; analyzing hybridization of a known amount of reference oligonucleotides (having the same sequences as the target oligonucleotides) to a calibration microarray; and determining the level of the target oligonucleotides in the sample by comparing the hybridization of the target oligonucleotides with the hybridization of the reference oligonucleotides.

### BACKGROUND

Since the discovery of the biological activity of short interfering RNAs (siRNAs) over a decade ago, so called “small RNAs” (i.e., short non-coding regulatory RNAs that have a defined sequence) have become a subject of intense interest in the research community. See Novina et al., (2004) Nature 430:161-164. Exemplary small RNAs include siRNAs, microRNAs (miRNAs), tiny non-coding RNAs (tncRNAs) and small modulatory RNAs (smRNAs), as well as many others.

Although the exact biological functions of most small RNAs remain a mystery, it is clear that they are abundant in plants and animals, with up to tens of thousands of copies per cell. For example, to date, over 150 Drosophila microRNA species and 600 human microRNA species have been identified. The levels of the individual species of small RNA, in particular microRNA species, appear to vary according to the developmental stage and type of tissue being examined. It is thought that the levels of particular small RNAs may be correlated with particular phenotypes, as well as with the levels of particular messenger RNAs and proteins. Further, viral microRNAs have been identified, and their presence has been linked to viral latency (see Pfeffer et al., (2004) Science 304:734-736).

The sequences of several hundred miRNAs from a variety of different species, including humans, may be found at the microRNA registry (Griffiths-Jones (2004) Nucl. Acids Res. 32:D109-D111), as found at the world-wide website of the Sanger Institute (Cambridge, UK) (which may be accessed by typing “www” followed by “.sanger.ac.uk/cgi-bin/Rfam/mirna/browse.pl” into the address bar of a typical internet browser). The sequences of all of the microRNAs deposited at the microRNA registry, including more than 300 microRNA sequences from humans (see Lagos-Quintana et al(2001) Science 294:853-858; Grad et al, (2003) Mol Cell 11:1253-1263; Mourelatos et al, (2002) Genes Dev 16:720-728; Lagos-Quintana et al, (2002) Curr Biol 12:735-739; Lagos-Quintana et al, (2003) RNA 9:175-179; Dostie et al, (2003) RNA 9:180-186; Lim et al, (2003) Science 299:1540; Houbaviy et al, (2003) Dev Cell 5:351-358; Michael et al, (2003) Mol Cancer Res 1:882-891; Kim et al, (2004) Proc Natl Acad Sci USA 101:360-365; Suh et al, (2004) Dev Biol 270:488-498; Kasashima et al. (2004) Biochem Biophys Res Commun 322:403-410; and Xie et al. (2005) Nature 434:338-345), are incorporated herein by reference. MicroRNAs (miRNAs) are a class of single stranded RNAs of approximately 19-25 nt (nucleotides) in length.

Thus, analysis of miRNA may be of great importance, for example as a research or diagnostic tool. Analytic methods employing polynucleotide arrays have been used for investigating small RNAs, e.g. miRNAs have become a subject of investigation with microarray analysis. See, e.g., Liu et al. (2004) Proc. Natl. Acad. Sci. USA, 101:9740-9744; Thomson et al. (2004) Nature Methods 1:1-7; and Babak et al. (2004) RNA, 10:1813-1819. A considerable amount of effort is currently being put into developing array platforms to facilitate the analysis of small RNAs, particularly microRNAs. Polynucleotide arrays (such as DNA or RNA arrays) typically include regions of usually different sequence polynucleotides (“capture agents”) arranged in a predetermined configuration on an array support. The arrays are “addressable” in that these regions (sometimes referenced as “array features”) have different predetermined locations (“addresses”) on the array support. The polynucleotide arrays typically are fabricated on planar array supports either by depositing previously obtained polynucleotides onto the array support in a site specific fashion or by site specific in situ synthesis of the polynucleotides upon the array support. After depositing the polynucleotide capture agents onto the array support, the array support is typically processed (e.g., washed and blocked for example) and stored prior to use.

In use, an array is contacted with a sample (e.g. a labeled sample) containing analytes (typically, but not necessarily, other polynucleotides) under conditions that promote specific binding of the analytes in the sample to one or more of the capture agents present on the array. Thus, the arrays, when exposed to a sample, will undergo a binding reaction with the sample and exhibit an observed binding pattern. This binding pattern can be detected upon interrogating the array. For example all target polynucleotides (for example, DNA) in the sample can be labeled with a suitable label (such as a fluorescent compound), and the label then can be accurately observed (such as by observing the fluorescence pattern) on the array after exposure of the array to the sample. Assuming that the different sequence polynucleotides were correctly deposited in accordance with the predetermined configuration, then the observed binding pattern will be indicative of the presence or concentration of one or more components of the sample. Techniques for scanning arrays are described, for example, in U.S. Pat. No. 5,763,870 and U.S. Pat. No. 5,945,679. Still other techniques useful for observing an array are described in U.S. Pat. No. 5,721,435.

Straightforward and reliable methods for simultaneously analyzing several constituents of a complex RNA sample are extremely desirable. While current methods of preparing and analyzing RNA samples are quite useful, there is a continuing need for development of such methods.

### Literature of Interest

Literature of interest includes: Novina et al (2004) Nature 430:161-164; Liu et al. (2004) Proc. Natl. Acad. Sci. 101:9740-9744; Thomson et al. (2004) Nature Methods 1:1-7; Babak et al. (2004) RNA 10:1813-1819; Wang et al. (2007) RNA 13:1-9; Pfeffer et al. (2004) Science 304:734-736; Nelson et al. (2001) Science 294:88-862; Liu et al. (1999) Nanobiology 4: 257-262; Walter et al. (1994) Proc. Natl. Acad. Sci. 91:9218-9222; Ambros et al. (2003) RNA 9:277-279; Baskerville et al. (2005) RNA 11:241-247; and Griffiths-Jones (2004) Nucl. Acids Res. 32:D109-D111.

### SUMMARY

In some embodiments, the disclosure relates to novel methods and kits for performing an array analysis of a sample. In some embodiments, there are provided methods of quantifying the level of a target oligonucleotide in a sample. The target oligonucleotides are labeled and contacted with a test array comprising a set of probes bound to an array support. The test array is then interrogated to obtain information about the oligonucleotide in the sample. A known amount of a reference oligonucleotide having the same sequence as the target oligonucleotide in the sample is similarly labeled, contacted with a calibration array, and interrogated to determine a relationship between the detected binding of the reference oligonucleotide and the known amount. The relationship is used to determine the level of oligonucleotide in the sample. In some embodiments, the test microarray and the calibration array are identical with respect to their probe nucleic aids.

In some embodiments, the disclosure relates to a computer program product for use with methods such as described herein. Kits for use in practicing the subject methods are also provided. The disclosed methods and kits find use in a wide variety of diagnostic and research applications.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows representative miRNA melting curves.

FIG. 2 shows estimated yields of 57 synthetic miRNAs.

FIG. 3 illustrates the linear dynamic range of microarray signals.

FIG. 4 illustrates the linear dynamic range of microarray signals.

FIG. 5 illustrates serial additions of a set of reference miRNA oligonucleotides to total RNA from HeLa cells.

### DESCRIPTION

In some embodiments, there are provided methods for determining the level of a target oligonucleotide in a sample. The methods comprise measuring hybridization of the target oligonucleotide to a test microarray; measuring hybridization of a known amount of a reference oligonucleotide to a calibration microarray, wherein the reference oligonucleotide comprises the same sequence as the target oligonucleotide, wherein the test array and the calibration array comprise a probe capable of forming a duplex with the target oligonucleotide; and, determining the level of the target oligonucleotide in the sample by comparing the hybridization of the target oligonucleotide with the hybridization of the reference oligonucleotide. In some embodiments, the test microarray and the calibration microarray are identical with respect to their probe nucleic acids. In some embodiments, the oligonucleotide comprises a small RNA, such as miRNA. In some embodiments, a plurality of different levels of reference oligonucleotide are each hybridized with a different calibration microarray, and a calibration data are obtained. The calibration data can be used to prepare a curve relating level of reference oligonucleotide with detectable signal. The hybridization of the reference oligonucleotide need not be performed contemporaneously with that of the target oligonucleotide. The hybridization or analysis of the reference oligonucleotide can be performed before, during, or after the hybridization of the target oligonucleotide. The test microarray can include a plurality of different probes for analyzing a plurality of different target oligonucleotides. A set of different reference oligonucleotides corresponding to the plurality of different probes can be used for binding to a calibration array.

The present disclosure is based in part on the discovery by Applicants, that as long as the same labeling and hybridization procedures are followed for a given platform, the signal obtained from a known amount of an oligonucleotide is highly reproducible. Data from the analysis of a reference oligonucleotide on one array can therefore be used to analyze the binding of a target oligonucleotiode on a separate array. A calibration curve obtained from the reference oligonucleotide binding can be prepared before, during, or after the hybridization of target oligonucleotides. Thus, in some embodiments, a calibration curve can be predetermined, and used in the subsequent analysis of target oligonucleotides. In some embodiments, the test microarray comprises a different target specific probe for each of the target oligonucleotides and each of the different target specific probes has a melting temperature for its respective target oligonucleotide within about 5° C. of the other target specific probes. In some embodiments, the melting temperatures for the probes of the test microarray are within the range of 50° C. to 60° C. In some embodiments, a probe contains a region that base-pairs with a polynucleotide to form a duplex and a Tₘ enhancement domain that increases the stability of the duplex. The Tₘ enhancement domain may contain a nucleotide clamp or a hairpin structure, for example. In some embodiments, the hybridization yield of each probe with its respective target oligonucleotide is between about 50% and 90%.

### Definitions

Before presenting the disclosure in detail, it is to be understood that this disclosure is not limited to specific compositions, method steps, kits, apparatus, or systems, as such can vary. It is also to be understood that the terminology used herein is not intended to be limiting. Methods recited herein can be carried out in any order of the recited events that is logically possible, as well as the recited order of events. Furthermore, where a range of values is provided, it is understood that every intervening value, between the upper and lower limit of that range and any other stated or intervening value in that stated range is encompassed within the present disclosure. Also, it is contemplated that any optional feature of the disclosed variations described can be set forth and claimed independently, or in combination with any one or more of the features described herein.

Unless defined otherwise below, all technical and scientific terms used herein have the same meaning as commonly understood by one of ordinary skill in the art to which this invention belongs. Still, certain elements are defined herein for the sake of clarity.

All literature and similar materials cited in this application, including but not limited to patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this application, including but not limited to defined terms, term usage, described techniques, or the like, this application controls.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

“May” means optionally.

The terms “determining”, “measuring”, “evaluating”, “assessing” and “assaying” are used interchangeably herein to refer to any form of measurement, and include determining if an element is present or not. These terms include both quantitative and/or qualitative determinations. Assessing may be relative or absolute. “Assessing the presence of” includes determining the amount of something present, as well as determining whether it is present or absent.

The term “using” has its conventional meaning, and, as such, means employing, e.g., putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier.

As used herein the phrase “small RNA” refers to an RNA including no more than about 100 nucleotides (e.g., no more than about 50 nucleotides, or no more than about 30 nucleotides). Small RNAs include: microRNA (miRNA), tiny non-coding RNA (tncRNA), short interfering RNA (siRNA), small modulatory RNA (smRNA), and the like, and mixtures thereof. Small RNA are smaller than messenger RNA. Messenger RNA generally contains many hundreds or thousands or nucleotides. In certain situations, many small RNA can bind to a single molecule of messenger RNA.

As used herein, the term “microRNA” or “miRNA” refers to a class of small noncoding RNAs. miRNA has been observed to contain, for example, about 20 to about 30 nucleotides (nt). miRNAs are single-stranded RNAs that can be produced from hairpin containing RNA molecules.

As used herein, the term “nucleic acid” refers to a polymer made up of nucleotides, e.g., deoxyribonucleotides or ribonucleotides.

As used herein, the terms “ribonucleic acid” and “RNA” refers to a polymer that includes at least one ribonucleotide, e.g., a polymer made up completely of ribonucleotides.

As used herein, the terms “deoxyribonucleic acid” and “DNA” refers to a polymer made up of deoxyribonucleotides.

As used herein, the term “polynucleotide” includes a nucleotide multimer having any number of nucleotides (for example 10 to 200, or more). This includes polynucleotides in which the conventional backbone has been replaced with a non-naturally occurring or synthetic backbone, as well as polynucleotides containing synthetic or non-naturally occurring nucleotides in which one or more of the conventional or canonical bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a polynucleotide can include DNA (including cDNA), RNA, oligonucleotides, and PNA and other polynucleotides as described in U.S. Pat. No. 5,948,902 and references cited therein (all of which are incorporated herein by reference), regardless of the source. The citation of any publication is for its disclosure prior to the filing date and should not be construed as an admission that the present invention is not entitled to antedate such publication by virtue of prior invention.

A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides.

An “oligonucleotide” generally refers to a nucleotide multimer of about 10 to 100 nucleotides in length. The term “nucleic acid” and “polynucleotide” are used interchangeably herein to describe a polymer of any length composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions. The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like. “Analogues” refer to molecules having structural features that are recognized in the literature as being mimetics, derivatives, having analogous structures, or other like terms, and include, for example, polynucleotides incorporating non-natural (not usually occurring in nature) nucleotides, unnatural nucleotide mimetics such as 2′-modified nucleosides, peptide nucleic acids, oligomeric nucleoside phosphonates, and any polynucleotide that has added substituent groups, such as protecting groups or linking moieties.

As used herein, the phrases “percent (%) nucleic acid sequence identity” and “% nucleic acid sequence identity” used with respect to the target and the disclosed probes and arrays, or the complement thereof refers to the percentage of nucleotides in a sequence of interest or target that are identical with the nucleotides in the disclosed probes and arrays, or the complement thereof after aligning the sequences and introducing gaps, if necessary, to achieve the maximum percent sequence identity. Alignment for purposes of determining percent nucleic acid sequence identity can be achieved in various ways that are within the skill in the art, for instance, using publicly available computer software such as BLAST, BLAST-2, ALIGN, ALIGN-2 or Megalign (DNASTAR) software. Those skilled in the art can determine appropriate parameters for measuring alignment, including any algorithms. Sequence comparison programs including the publicly available NCBI-BLAST2 (Altschul et al. (1997) Nucleic Acids Res. 25:3389-3402) can be employed for calculating % identity with its search parameters set to default values.

As used herein, the phrase “stringent conditions” or “high stringency conditions” for hybridization of oligo or polynucleotides include, for example: washing at low ionic strength and high temperature, e.g., 0.015 M sodium chloride/0.0015 M sodium citrate/0.1% sodium dodecyl sulfate at 50° C.; hybridization in the presence of a denaturing agent, e.g., 50% (v/v) formamide with 0.1% bovine serum albumin/0.1% Ficoll/0.1% polyvinylpyrrolidone/50 mM sodium phosphate buffer at pH 6.5 with 750 mM sodium chloride, 75 mM sodium citrate at 42° C.; or hybridizing in 50% formamide, 5×SSC (0.75 M NaCl, 0.075 M sodium citrate), 50 mM sodium phosphate (pH 6.8), 0.1% sodium pyrophosphate, 5×Denhardt's solution, sonicated salmon sperm DNA (50 g/ml), an random sequenced 25-mer as blocker, 0.1% SDS, and 10% dextran sulfate at 42° C. and washing at 42° C. in 0.2×SSC (sodium chloride/sodium citrate) and 50% formamide followed by washing with 0.1×SSC containing EDTA at 55° C.

“Hybridizing” and “binding”, with respect to polynucleotides, are used interchangeably. “Hybridizing conditions” for a polynucleotide array refer to suitable conditions of time, temperature and the like, such that a target sequence present in solution will bind to an array feature carrying a complementary sequence to a greater extent than to features carrying only sequences which are not complementary to the target sequence (and preferably at least 20% or 100%, or even 200 or 500% greater). Generally, the subject methods comprise the following major steps: (1) provision of an array containing surface-bound subject nucleic acid probes; (2) hybridization of a population of labeled polynucleotides to the surface-bound nucleic acid probes, typically under high stringency conditions; (3) post-hybridization washes to remove nucleic acids not bound in the hybridization; and (4) detection of the hybridized nucleic acids. The reagents used in each of these steps and their conditions for use vary depending on the particular application.

As indicated above, hybridization is carried out under suitable hybridization conditions, which may vary in stringency as desired. In some embodiments, highly stringent hybridization conditions may be employed. The term “highly stringent hybridization conditions” as used herein refers to conditions that are compatible to produce nucleic acid binding complexes on an array surface between complementary binding members, i.e., between surface-bound subject nucleic acid probes and complementary labeled small RNAs in a sample. Representative high stringency assay conditions that may be employed in these embodiments are provided above.

The above hybridization step may include agitation of the immobilized targets and the sample of labeled nucleic acids, where the agitation may be accomplished using any convenient protocol, e.g., shaking, rotating, spinning, and the like.

Following hybridization, the surface of immobilized nucleic acids is typically washed to remove unbound labeled nucleic acids. Washing may be performed using any convenient washing protocol, where the washing conditions are typically stringent, as described above.

Following hybridization and washing, as described above, the hybridization of the labeled small nucleic acids to the array is then detected using standard techniques so that the surface of the array, is read. Reading of the resultant hybridized array may be accomplished by illuminating the array and reading the location and intensity of resulting fluorescence at each feature of the array to detect any binding complexes on the surface of the array. For example, a scanner may be used for this purpose that is similar to the AGILENT MICROARRAY SCANNER available from Agilent Technologies, Santa Clara, Calif. Other suitable devices and methods are described in and U.S. Pat. No. 6,406,849 and U.S. Pat. No. 6,756,202. However, arrays may be read by any other method or apparatus than the foregoing, with other reading methods including other optical techniques (for example, detecting chemiluminescent or electroluminescent labels), or electrical techniques (where each feature is provided with an electrode to detect hybridization at that feature in a manner disclosed in U.S. Pat. No. 6,221,583 and elsewhere).

Results from the reading or evaluating may be raw results (such as fluorescence intensity readings for each feature in one or more color channels) or may be processed results (such as those obtained by subtracting a background measurement, or by rejecting a reading for a feature which is below a predetermined threshold, normalizing the results, or forming conclusions based on the pattern read from the array (such as whether or not a particular target sequence may have been present in the sample, or whether or not a pattern indicates a particular condition of an organism from which the sample came). Since the arrays used in the subject assays may contain nucleic acid probes for a plurality of different polynucleotides, the presence of a plurality of different polynucleotides may be assessed. The subject methods are therefore suitable for simultaneous assessment of a plurality of polynucleotides in a sample.

If a subject nucleic acid probe “corresponds to” or is “for” a certain oligonucleotide, such as a certain small RNA, the nucleic acid probe base pairs with, i.e., specifically hybridizes to, that small RNA. As will be discussed in greater detail below, a nucleic acid probe for a particular small RNA and the particular small RNA, or complement thereof, usually contains at least one region of contiguous nucleotides that is identical in sequence.

The term “mixture”, as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not especially distinct. In other words, a mixture is not addressable. To be specific, an array of surface bound polynucleotides, as is commonly known in the art and described below, is not a mixture of capture agents because the species of surface bound polynucleotides are spatially distinct and the array is addressable.

“Isolated” or “purified” generally refers to isolation of a substance (compound, polynucleotide, protein, polypeptide, polypeptide, chromosome, etc.) such that the substance comprises the majority percent of the sample in which it resides. Typically in a sample a substantially purified component comprises 50%, preferably 80%-85%, more preferably 90-95% of the sample. Techniques for purifying polynucleotides and polypeptides of interest are well known in the art and include, for example, ion-exchange chromatography, affinity chromatography, flow sorting, and sedimentation according to density.

An “array”, unless a contrary intention appears, includes any one-, two- or three-dimensional arrangement of addressable regions bearing a particular chemical moiety or moieties (for example, biopolymers such as polynucleotide sequences) associated with that region. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probes” may be the one which is to be evaluated by the other (thus, either one could be an unknown mixture of polynucleotides to be evaluated by binding with the other). Target probes may be covalently bound to a surface of a non-porous or porous substrate either directly or through a linker molecule, or may be adsorbed to a surface using intermediate layers (such as polylysine) or porous substrates.

An “array layout” refers to one or more characteristics of the array or the features on it. Such characteristics include one or more of: feature positioning on the substrate; one or more feature dimensions; some indication of an identity or function (for example, chemical or biological) of a moiety at a given location; how the array should be handled (for example, conditions under which the array is exposed to a sample, or array reading specifications or controls following sample exposure).

A “pulse jet” is a device which can dispense drops in the formation of an array. Pulse jets operate by delivering a pulse of pressure to liquid adjacent an outlet or orifice such that a drop will be dispensed therefrom (for example, by a piezoelectric or thermoelectric element positioned in a same chamber as the orifice).

An array “package” may be the array plus only a substrate on which the array is deposited, although the package may include other features (such as a housing with a chamber).

A “region” refers to any finite area, for example a finite area on the array that can be illuminated and any resulting fluorescence therefrom simultaneously (or shortly thereafter) detected, for example a pixel.

A “quantitative measurement” of a target polynucleotide in a sample is an accurate determination of the number of copies of that sequence in the original sample, which may be expressed, for example, as fmol of target polynucleotides, as fmol of target polynucleotide/μg of sample, or in other physical units. The uncertainty of the measurement, in the same units, may also be reported.

Hybridizing “toward equilibrium” means letting the hybridization proceed at least long enough for the fraction of the target hybridized to probes to exceed half of that which would be hybridized at equilibrium (i.e. after infinite time). The length of time required to achieve this condition depends on the rate constant of the target polynucleotide at the hybridization temperature, and on the probe concentration.

The “melting temperature” (Tₘ) of a probe is the temperature at which half of the sequences targeted by that probe are bound, and half are unbound, at equilibrium. The Tₘ of a probe depends on the inherent stability of the probe-target hybrid (ΔG) and on the probe concentration.

The “binding constant” (Keq) of a target is the equilibrium constant of the hybridization reaction: target+probe< >bound_target. As is well known, the Keq is related to the free energy of reaction as: ΔG=−RT ln(Keq).

The “hybridized recovery” of a target is the total amount of labeled target which binds to its complementary probe and is detected.

The “hybridization yield” of a target is the fraction of the labeled target which binds to its complementary probe and is detected. That is, it is the hybridized recovery divided by the original amount of labeled target in the sample mixture presented to the array. The hybridization yield depends on the binding constant (Keq) between the probe and its target, the probe concentration, and the length of time allowed for hybridization.

“Selectivity” is the ability to discriminate between the targets of interest and other non-target sequences which may be present in the sample. Selectivity may be described as the ratio of the reported signal that is due to the desired target, to the total reported signal.

As used herein, “sample” refers to any substance containing or presumed to contain a nucleic acid of interest (a target nucleic acid) or which is itself a nucleic acid containing or presumed to contain a target nucleic acid of interest. The term “sample” thus includes a sample of nucleic acid (genomic DNA, cDNA, RNA), cell, organism, tissue, fluid, or substance including but not limited to, for example, plasma, serum, spinal fluid, lymph fluid, synovial fluid, urine, tears, stool, external secretions of the skin, respiratory, intestinal and genitourinary tracts, saliva, blood cells, tumors, organs, tissue, samples of in vitro cell culture constituents, natural isolates (such as drinking water, seawater, solid materials), microbial specimens, and objects or specimens that have been “marked” with nucleic acid tracer molecules.

A “processor” references any hardware or software combination which will perform the functions required of it. For example, any processor herein may be a programmable digital microprocessor such as available in the form of a mainframe, server, or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic or optical disk may carry the programming, and can be read by a suitable disk reader communicating with each processor at its corresponding station.

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

The term “predetermined” refers to an element whose identity is known prior to its use. For example, a “predetermined analyte” is an analyte whose identity is known prior to any binding to a capture agent. For example, a predetermined calibration data is known prior to its use in analyzing the level of a target oligonucleotide from a sample. An element may be known by name, sequence, molecular weight, its function, or any other attribute or identifier.

For purposes of simplifying the description herein, and not by way of limitation, miRNA will be primarily described herein, it being understood that other polynucleotides are intended to be included within the scope of this disclosure.

### Methods of Quantifying Small RNA

The present disclosure relates to methods for quantifying an oligonucleotide, such as a small RNA, methods for detecting or quantifying binding to a nucleic acid array, and the arrays, and probes that can be used in such methods and arrays.

In some embodiments, there are disclosed methods for detecting a small RNA such as an miRNA. The methods can include providing a probe including nucleotides complementary to nucleotides of the small RNA. Non-limiting examples of suitable probes are described, for example, in Published U.S. Patent Application Nos. 20070003937 and 20070003940, and Wang et al. (2007) RNA 13:1-9. For example, the probe can be complementary to consecutive nucleotides (e.g., about 10 consecutive nucleotides) of the small RNA, such as consecutive nucleotides at or near the 3′ end of the small RNA. In some embodiments, the small RNA is an miRNA and the probe is complementary to at least about 10 consecutive nucleotides of the miRNA. The probe can be complementary to consecutive nucleotides starting at the 3′ end of the small RNA, starting at the nucleotide adjacent to the 3′ nucleotide (the second nucleotide from the 3′ end), at the third nucleotide from the 3′ end, at the fourth nucleotide from the 3′ end, at the fifth nucleotide from the 3′ end, or at the sixth nucleotide from the 3′ end. In other words, in some embodiments, the methods can employ a probe for binding to small RNA omits (does not include) a sequence complementary to a portion of the small RNA, wherein the portion consists of the 3′-terminal 1, 2, 3, 4, 5, or 6 nucleotides of the small RNA.

The probe can include any number of nucleotides suitable for binding to the small RNA. For example, in some embodiments, the probe can include about 10 to about 30 (e.g., 32) consecutive nucleotides complementary to consecutive nucleotides of the small RNA. In some embodiments, the probe can include about 12 to about 25 consecutive nucleotides complementary to consecutive nucleotides of the small RNA. In some embodiments, the probe can include about 12 to about 18 consecutive nucleotides complementary to consecutive nucleotides of the small RNA. In some embodiments, the methods employ a probe including at least 6, at least 7, or at least 12 consecutive nucleotides complementary to consecutive nucleotides starting from the 3′ end of an miRNA.

The probe can also include a heterologous polynucleotide. The heterologous polynucleotide can include a number of nucleotides effective to, for example, couple the probe to a support. In some embodiments, the heterologous polynucleotide can include about 10 to about 100 nucleotides, about 10 to about 60 nucleotides, or about 10 to about 30 nucleotides. The heterologous nucleotides can be coupled to the consecutive nucleotides that are complementary to the small RNA. In some embodiments, the heterologous polynucleotide can include a “stilt” polynucleotide. The stilt polynucleotide can be configured to couple the complementary nucleotides to a support. Such heterologous nucleotide may include a nucleotide clamp sequence or a hairpin such as is described below.

Without wishing to be bound by theory, it is believed that many miRNAs may have a 3′ end with less complementary base pairing with its target mRNA than the 5′ end of the miRNA. For example, Applicants have determined that most known miRNAs have high sequence complementarity with their target messenger RNA for the first eight 5′ nucleotides of the miRNA. For such an miRNA, the 3′ end of the miRNA is more susceptible to binding to a probe having about 10 (e.g., 8) or more consecutive base pairing nucleotides for the 3′ end of the miRNA.

### Nucleic Acid Probes Containing a Tm Enhancement Domain

In some embodiments, there is provided a nucleic acid probe for detecting a polynucleotide wherein the probe contains a region that base-pairs with a polynucleofide to form a duplex and a Tₘ enhancement domain that increases the stability of the duplex (e.g., as described in Published U.S. Pat. Application No. 20070003940). The Tₘ enhancement domain may contain a nucleotide clamp or a hairpin structure, for example. The methods can utilize an array of such nucleic acid probes bound to a surface of the solid support.

In some embodiments, a probe contains: a first region (i.e., a “binding region”) that base-pairs with a small RNA to form a duplex; and a Tₘ enhancement domain that increases stability of the duplex. In some embodiments, the nucleic acid probe may be attached to a solid support, optionally via a linker.

The nucleic acid probes as described herein may be used to detect any type of polynucleotide, including DNA (including oligonucleotides, genomic fragments and PCR products, or any fragmented version thereof, for example) and RNA (including small RNAs, cDNAs, rRNA, tRNA, piRNA, or any fragmented version thereof, etc.). The polynucleotide to be detected generally has a 3′ end or 5′ end (depending on which end of the nucleic acid for detecting that polynucleotide is attached to the solid support) of known sequence. In some embodiments, the nucleic acid probes of the disclosure can be used in detecting “small RNA” (or “short RNA” as it may also be referred to), where the terms “small RNA” and “short RNA” are used interchangeably herein as they are used in the art, i.e., to describe a group of non-coding regulatory RNAs that have defined sequences and that are in the range of 19-30 nucleotides (nts) in length.

In some embodiments, a subject nucleic acid probe may be in the range of about 10 to about 100 bases in length. In some embodiments, a subject nucleic acid probe may be about 18 to about 70 bases, about 19 to about 60 bases, or about 20 to about 50 bases in length. As noted above, in some embodiments, a subject nucleic acid probe generally contains a region that base-pairs with an oligonucleotide to form a duplex and a duplex Tₘ enhancement domain. The binding region generally contains a contiguous nucleotide sequence that is complementary to the nucleotide sequence of a corresponding target polynucleotide and is of a length that is sufficient to provide specific binding between the nucleic acid probe and the corresponding target polynucleotide. In some embodiments, a binding region can be at least about 19 nt in length and in some embodiments may be as long as 22 nt, 25 nt or 29 nt in length, or longer or, in some embodiments, as short as 10-12 nucleotides. The nucleic acid probe, if it is attached to a solid support, may be attached via its 3′ end or its 5′ end. If the nucleic acid probe is attached to a solid support via its 3′ end, the nucleotide at the 5′ end of the first region of the nucleic acid probe generally base pairs with the 3′ terminal nucleotide of a polynucleotide to be detected. Conversely, if the nucleic acid probe is attached to a solid support via its 5′ end, the nucleotide at the 3′ end of the first region of the nucleic acid probe generally base pairs with the 5′ terminal nucleotide of a polynucleotide to be detected. A subject nucleic acid probe need not be complementary to the entire length of a corresponding polynucleotide to be detected, and a polynucleotide to be detected need not be complementary to the entire length of a subject nucleic acid probe.

The binding region therefore corresponds to, i.e., hybridizes to and may be used to detect, a particular polynucleotide. In some embodiments, the binding region is specific for a particular small RNA, i.e., is “small RNA-specific”, in that it can detect a small RNA, even in the presence of other RNAs, e.g., other small RNAs. In other words, a subject nucleic acid probe contains a binding region that is complementary to a particular small RNA.

The Tₘ enhancement domain of a subject nucleic acid probe increases the stability of the duplex formed by binding of a small RNA to region of the nucleic acid probe. Tₘ enhancement domain may increase duplex stability via a number of mechanisms, including, for example, by providing a nucleotide clamp to which an extended polynucleotide, e.g., extended small RNA, may bind, or by providing a hairpin structure that increases stability via coaxial stacking. In some embodiments, a Tₘ enhancement domain may contain both a nucleotide clamp and a hairpin structure. The sequence of the Tₘ enhancement domain is generally unrelated to the sequence of the binding region.

A Tₘ enhancement domain is immediately adjacent to a binding region and may contain a nucleotide clamp, where a nucleotide clamp contains a contiguous sequence of up to about 5 nucleotides (i.e., 1, 2, 3, 4 or 5 nucleotides). The identity of the nucleotides employed in the nucleotide clamp may be the same as each other or different to each other. As will be described in greater detail below and in some embodiments, a subject nucleic acid probe containing a nucleotide clamp is employed in a method in which the polynucleotide to be detected by the nucleic acid probe is extended (in some embodiments during labeling of the polynucleotide) to produce an extended small RNA. In the duplex formed between a polynucleotide probe containing a nucleotide clamp and an extended polynucleotide, the extended portion of the extended polynucleotide base-pairs with the Tₘ enhancement domain (i.e., the clamp) of the nucleic acid probe and the non-extended polynucleotide sequence base pairs with binding region. The addition of the nucleotide clamp increase the stability of the duplex, as compared to a duplex formed in the absence of the clamp. As would be apparent to one of skill in the art, the polynucleotide may be extended by nucleotides that are the same in number as and base pair with nucleotides that are present in the nucleotide clamp of the probe. In some embodiments, a nucleotide clamp contains N₁₋₅, wherein “N” is any nucleotide, particularly a G or a C. In some embodiments, a nucleotide clamp may contain one or two C or G residues. In other words and in some embodiments, a subject nucleic acid probe may contain a first region that is complementary to at least 19 contiguous nucleotides at one end of a small RNA as well as a nucleotide clamp immediately adjacent to that region.

Depending on which end of the nucleic acid probe is attached to the solid support, a nucleotide clamp may be linked to the 3′ end or 5′ end of the binding region. In some embodiments, the 3′ end of the nucleic acid probe is attached to the solid support and the 3′ end of the nucleotide clamp is linked to the 5′ end of binding region. In some embodiments, a Tₘ enhancement domain is immediately adjacent to a binding region and may contain a hairpin structure, where a hairpin structure has a loop of at least 3 or 4 nucleotides and a double-stranded stem in which complementary nucleotides bind to each other in an anti-parallel manner. The hairpin structure may contain from approximately 5 to about 30 nucleotides, e.g., about 8-20 nucleotides. The 5′ terminal nucleotide of the hairpin generally base-pairs with the 3′ terminal nucleotide of the hairpin, regardless of which end of the nucleic acid probe is bound to the solid support. In a duplex formed between a nucleic acid probe containing a hairpin region and a polynucleotide, the hairpin region promotes a phenomenon termed stacking (which phenomenon may also be called coaxial stacking) which allows the polynucleotide to bind more tightly, i.e., more stably. When labeled polynucleotide is bound to a nucleic acid probe containing a hairpin region, a terminal nucleotide of the labeled polynucleotide generally occupies a position that is immediately adjacent to a terminal nucleotide of the nucleic acid probe. In effect, in this embodiment, the duplex produced by binding of a labeled polynucleotide to a nucleic acid probe resembles a long hairpin structure containing a nick in the stem of the hairpin. Stacking and its effect on duplex stability are discussed in Liu et al (1999) Nanobiology 4: 257-262, Walter et al (1994) Proc. Natl. Acad. Sci. 91:9218-9222 and Schneider et al (2000) J. Biomol. Struct. Dyn. 18:345-52, as well as many other references.

Depending on which end of the nucleic acid probe is attached to the solid support, a hairpin structure may be linked to the 3′ or 5′ end of a binding region. In some embodiments, the 3′ end of the nucleic acid probe is attached to the solid support and the 3′ end of the hairpin is linked to the 5′ end of binding region.

In some embodiments, a nucleic acid probe may contain a Tₘ enhancement domain containing both a nucleotide clamp and a hairpin structure. An extended polynucleotide bound to such a probe is bound more tightly to the probe, as compared to the binding of the same polynucleotide to an equivalent nucleic acid probe solely containing a binding region.

The Tₘ enhancement domain effectively increases the stability (i.e., increases the tightness of binding and increases the melting temperature Tₘ) of a duplex containing a nucleic acid probe and a polynucleotide, as compared to the stability of a duplex obtained using a nucleic acid probe that does not contain the Tₘ enhancement domain. The addition of the Tₘ enhancement domain to a nucleic acid probe for detecting a small RNA increases the Tₘ of the probe by at least 1° C., and, in some embodiments, by about 2° C., 3° C., 4° C. or 5° C. or more, up to about 10° C., as compared to an otherwise identical nucleic acid probe that does not contain the Tₘ enhancement domain.

In addition to increasing the Tₘ of a duplex, the use of a Tₘ enhancement domain, particularly a hairpin structure, in a probe allows the probe to discriminate between different polynucleotides that are perfectly complementary to the probe. For example, in some embodiments, a probe containing a hairpin region is designed so that the end of the probe (i.e., the end of the probe that is not attached to the solid support) is immediately adjacent to a terminal nucleotide of a polynucleotide when the polynucleotide is bound by the probe. This arrangement induces stacking, which, as explained above, increases the strength of binding between the nucleic acid probe and polynucleotide. If the terminal nucleotide of the polynucleotide does not lie immediately next to the nucleotide at the end of the probe (for example, if the polynucleotide is longer or shorter than the polynucleotide to be detected), then no stacking occurs. Accordingly, a subject hairpin structure-containing nucleic acid probe that is designed to detect a small RNA, in particular a miRNA, can discriminate between the small RNA and its precursor because only that small RNAs and not its precursor, when bound to such a nucleic acid probe, effects stacking. In other words, the hairpin structure provides for stearic hindrance of non-target polynucleotides.

In some embodiments, the subject disclosure provides methods of determining the amount of a polynucleotide, e.g., small RNA such as a particular miRNA, in a sample of polynucleotides that are labeled with a detectable label. In general, the method includes the following steps: a) contacting a subject nucleic acid probe with the sample under conditions sufficient for specific binding to occur between the nucleic acid probe and the labeled polynucleotides; and b) evaluating the presence of any detectable label associated with the nucleic acid probe, thereby evaluating the amount of the analyte in the sample.

In embodiments in which a nucleic acid probe containing a nucleotide clamp is employed, the polynucleotide of a sample of mixed polynucleotides may be extended to add nucleotides that are complementary to the nucleotide clamp of the nucleic acid probe. The addition of the nucleotides to the polynucleotides may be done before, simultaneously with or after labeling. In some embodiment, a mononucleotide, di-nucleotide, tri-nucleotide, tetra-nucleotide or penta-nucleotide moiety is added to either the 3′ or the 5′ ends of the polynucleotides of a sample of polynucleotides using an enzyme, e.g., an RNA or DNA ligase or terminal transferase. A variety of RNA and DNA ligases may be purchased from a variety of vendors (e.g., Pharmacia, Piscataway, N.J., New England Biolabs, Beverly, Mass., and Roche Diagnostics, Indianapolis, Ind.) and employed according to the instructions supplied therewith. In some embodiments, the nucleotide(s) added to the polynucleotides are covalently linked to a label, e.g., a fluorophore, such that the polynucleotide is labeled by the addition of the fluorescent nucleotide. Labeled mononucleotides, di-nucleotides, tri-nucleotides, tetra-nucleotides, penta-nucleotides or higher order labeled polynucleotides are termed “nucleotide label moieties” herein.

### Melting Temperatures

Some embodiments provide methods using the disclosed probes in which each probe is specific for a target and has a melting temperature for their respective target within about 15° C., within about 10° C., or within about 5° C. of each other. Generally, one or more probes optionally having different sequences of monomers or a different number of monomers are selected based on their melting temperatures for their respective targets. In some embodiments, the probes have melting points for their targets in the range of about 50° to about 60° C. Probes can have different monomer sequences as well as different numbers of monomers, but selected probes will each have a melting temperature for their respective targets within about 15° C., within about 10° C., or within about 5° C. of each other. Probes specific for different targets also can have different sequences and different numbers of monomers provided they each have a melting temperature for their respective targets of within about 15° C., within about 10° C., or within about 5° C. of each other. The probes are generally DNA, but can also include RNA, or can be a combination of RNA and DNA. The targets or probes are naturally occurring or non-naturally occurring polymers including, but not limited to nucleic acids such as RNA, DNA, PNA, polypeptides, and combinations thereof.

In some embodiments, an array includes probes and every one of the probes has a melting temperature for their respective target within about 15° C., within about 10° C., or within about 5° C. of each other. In some embodiments, all of the probes in the array have melting points for their targets in the range of about 50° to about 60° C. In some embodiments, an array includes probes and 80% of the probes have a melting temperature for their respective target within about 15° C., within about 10° C., or within about 5° C. of each other. In some embodiments, 80% of the probes in the array have melting points for their targets in the range of about 50° to about 60° C.

In some embodiments, an array for using the present methods may contain probes that all have a similar Tₘ. The spread of Tₘs of such arrays may be less than about 10° C., less than about 5° C., or less than about 2° C., for example. The spread of Tₘs of an array may be theoretically determined, or, in some embodiments, experimentally determined.

Some embodiments provide determining the melting temperature of one or more probes for one or more targets. Representative probes are polymers including, but not limited to polymers of a single monomer (homopolymers) or polymers of more than one monomer (heteropolymers). Monomers can be non-naturally occurring or naturally occurring monomers such as deoxyribonucleotides, ribonucleotides, amino acids, sugars, carbon atoms, or derivatives thereof. The transition of double-stranded to single-stranded conformation can be monitored as an increase in absorbance and is marked by a sharp change in the extinction coefficient at the temperature where the conformational transition takes place. The temperature corresponding to the midpoint of the absorbance rise is called the melting temperature (Tₘ). In structural terms, Tₘ is the temperature at which 50% of the base pairs in the duplex have been denatured. Methods for determining the melting temperature of nucleic acid duplexes are known in the art. See for example, Sambrook and Russell (2001) Molecular Cloning: A Laboratory Handbook, 10.38-10.41 and 10.47. Any nucleic acid probe designed according to the methods outlined herein may be experimentally or computationally tested and altered until a nucleic acid probe having desired Tm is obtained. Methods for experimentally and computationally determining the Tₘ of a nucleic acid duplex are well known in the molecular biology arts. In some embodiments, the Tm of a nucleic acid may be calculated using the methods described in Published U.S. Patent Application 20070003939.

Tₘ can be determined mathematically using equations and algorithms known in the art. For duplex oligonucleotides shorter than 25 bp, “The Wallace Rule” can be used in which:

Tₘ (in ° C.)=2(A+T)+4(C+G), where

(A+T)—the sum of the A and T residues in the oligonucleotide,

(C+G)—the sum of G and C residues in the oligonucleotide

(Wallace, R. B., et al. (1979 Hybridization of synthetic oligodeoxyribonucleotides to phiX174 DNA: the effect of single base pair mismatch, Nucleic Acids Res. 6:3543-3557). Computer programs for estimating Tₘ are also available (Nicolas Le Novere (2001), MELTING, computing the melting temperature of nucleic acid duplex. Bioinformafics 17(12):1226-1227). VisualOmp (DNA Software, Inc., Ann Arbor, Mich.) is an example of commercially available software for calculating probe:target duplex melting temperature.

Tₘ can also be determined empirically using methods known in the art (see, e.g., Sambrook and Russell (2001) Molecular Cloning: A Laboratory Handbook, 10.38-10.41). Generally, one strand of a duplex is labeled with a detectable label, typically on the 3′ end of the target. The unlabeled strand or probe is typically bound to a solid support. The labeled and unlabeled strands are brought into contact under various conditions and temperatures. The melting temperature can be determined by monitoring the amount of label that hybridizes to the bound unlabeled strand as a function of the hybridization temperature. Detectable label on the solid support indicates the presence of a duplex. As the hybridization temperature increases, more label is eluted from the solid support. As noted above, the presence of a Tₘ enhancement domain in a nucleic acid probe for detecting a polynucleotide of interest, e.g., a small RNA, increases the melting temperature of a duplex formed by a labeled polynucleotide and that nucleic acid probe. The ability to increase the melting temperature of such duplexes allows arrays having more favorable binding characteristics (as compared to arrays made using nucleic acid probes that do not contain stability sequences) to be designed and made. Accordingly, a nucleic acid probe for a polynucleotide may be designed and produced using the above-methods, and an array containing that nucleic acid probe may be fabricated.

In other words, the use of nucleic acid probes containing Tₘ enhancement domains allows a set of nucleic acid probes for detecting polynucleotides, e.g., small RNAs, to be designed to have a lower Tₘ spread (and, in some embodiments, higher average Tₘ) than a set of nucleic acid probes that do not contain Tₘ enhancement domains. The use of nucleic acid probes containing Tₘ enhancement domains can increase the overall specificity of binding between a set of nucleic acid probes and labeled polynucleotide for those probes, leading to more accurate results. In some embodiments, the use of such arrays allows highly stringent hybridization conditions to be employed. For example, fewer ions, a higher hybridization temperature, a higher wash temperature or a extended wash period may be employed in hybridizing the subject arrays with a sample containing labeled polynucleotides, as compared to arrays containing otherwise identical nucleic acid probes that do not contain Tₘ enhancement domains. For example, in hybridization of a subject array, salt concentration may be decreased or hybridization temperature may be increased in either the hybridization buffer employed or wash buffer employed, or both the hybridization and wash buffers employed for hybridization, as compared to an otherwise identical array that does not contain nucleic acid probes having stability sequences. A prolonged wash after the hybridization incubation may also be employed in the subject hybridization methods.

In some non-limiting embodiments, the sequences of a population of small RNAs (e.g., human or Drosophila miRNAs, for example), are identified, and complementary polynucleotide sequences are designed to hybridize with those small RNAs. The Tₘs of the complementary sequences are determined. In general terms, in order to provide a set of nucleic acid probes for those small RNAs, the sequence of the longer complementary polynucleotides are trimmed back to decrease their Tₘs (e.g., by 1, 2, 3, 4, 5, 6, nucleotides or more, depending on the desired Tₘ), and Tₘ enhancement domains are added to the shorter complementary polynucleotide sequences to increase their Tₘs. An array containing the designed set of nucleic acid probes, at least some of which contain a Tₘ enhancement domain, is then fabricated and the array is employed for the analysis of the population of small RNAs.

In some embodiments, particularly those embodiments in which a hairpin structure is employed as a Tₘ enhancement domain, a Tₘ enhancement domain may be added to all probes of an array, including both trimmed non-trimmed probes. The hairpin structure may assist in increasing probe specificity by preferentially binding to small RNAs, e.g., miRNAs, rather than pre-small RNAs (i.e., precursor RNAs that are cleaved to produce small RNAs, e.g., pre-miRNAs) in a sample. The presence of hairpin structure, in some embodiments, allows a probe to discriminate between a small RNA and a precursor of that small RNA that is present in same sample.

The Tₘs of a set of sequences complementary to the polynucleotides of a population of polynucleotides, e.g., small RNAs, are distributed across a Tₘ spread (a Tₘ spread being difference in temperature between the highest and lowest Tₘ of the set). The Tₘs may have an approximately normal distribution and form an approximate bell-shaped curve when plotted as shown. In designing nucleic acid probes for the polynucleotides, the length of the complementary sequences having a higher Tₘ is decreased (thereby decreasing the Tₘ of those sequences) and stability sequences are added to the complementary sequences having a lower Tₘ (thereby increasing the Tₘ of those sequences). Once the Tₘs of the population of complementary sequences have been adjusted by reducing the length of the sequences or by adding Tₘ enhancement domains, the spread of the Tₘs of the population is significantly reduced. Such a reduction in Tₘ spread is highly desirable in microarray analysis.

### Methods Employing Arrays of the Present Probes

The methods can include employing the probe in any of a variety of situations in which the probe can bind to a small RNA. For example, the methods can include contacting a sample suspected of containing the small RNA with the probe. Such methods can also include monitoring for binding of the small RNA to the probe. Monitoring for binding can employ an apparatus suitable for detecting binding that occurs. Should binding occur, the methods can include detecting binding of the small RNA to the array.

The methods can employ a plurality of probes that can bind to small RNA. Each individual probe can have the characteristics described above. The plurality of probes can include probes with different nucleic acid sequences. The different probes can be complementary to different small RNAs. In some embodiments, a probe of a particular sequence is complementary to a particular small RNA. In some embodiments, a plurality of probes each having a particular sequence are complementary to a plurality of particular small RNAs. In some embodiments, at least two of the plurality of probes include distinct sequences of nucleotides. A plurality of probes can be coupled to the support in an array format.

The methods can employ a plurality of probes that can bind to small RNA in a variety of amounts. Consider, for example, a method employing a first probe complementary to a first miRNA and a first probe complementary to a second miRNA. Such a method can employ the two probes in unequal amounts. For example, if a sample is suspected to contain the first miRNA in a 10,000 fold molar excess over the second miRNA, the methods can employ 10 probes complementary to the first miRNA (or features containing probes complementary to the first miRNA) for each probe or feature including probes complementary to the second miRNA. In some embodiments, the amounts of each first probe are proportional to an expected relative amount of first and second miRNA in a sample.

By way of further example, some embodiments of the methods can include one or more first probes in greater amounts. For example, certain miRNA sequences have a high propensity for cross hybridization. For such miRNAs, the present methods can include a greater number first probes that can hybridize to this miRNA. Although not wishing to be bound by theory, it is believed that such a greater quantity can reduce cross hybridization.

An exemplary method includes contacting a sample with a plurality of disclosed probes on an array. Contacting can include any of a variety of known methods for contacting an array with a reagent, sample, or composition. For example, the method can include placing the array in a container and submersing the array in or covering the array with the reagent, sample, or composition. The method can include placing the array in a container and pouring, pipetting, or otherwise dispensing the reagent, sample, or composition onto features on the array. Alternatively, the method can include dispensing the reagent, sample, or composition onto features of the array, with the array being in or on any suitable rack, surface, or the like.

The present methods can include contacting the nucleic acid array with a sample suspected of containing a polynucleotide that can bind to a feature on the array. The sample polynucleotide can include, for example, a gene, a transcript of the gene, a polynucleotide including a sequence from the gene, or a complement thereof. The method can include binding of the sample polynucleotide to a nucleic acid in a feature at a location on the array. Monitoring for binding can employ an apparatus suitable for detecting binding that occurs. Should binding occur, the method can include detecting binding of the sample polynucleotide to the array.

In some embodiments, the present methods can include contacting the nucleic acid array with a sample including a plurality of sample polynucleotides. At least one, or all, of the sample polynucleotides can be capable of or suspected of being capable of binding to one or more features on the array. The plurality of sample polynucleotides can each be from the same cell, tissue, or organism. The plurality of sample polynucleotides can include polynucleotides of interest, for example, with respect to development, disease, or disorder of the cell, tissue, or organism. At least one, or all, of the sample polynucleotides can include a detectable label.

In some embodiments, the present methods can include detecting a first detectable signal (e.g., color) from a standard polynucleotide and a second detectable signal from a sample polynucleotide. The methods can include comparing the strength of the first and second detectable signals.

Detecting can include any of a variety of known methods for detecting a detectable signal from a feature or location of an array. Any of a variety of known, commercially available apparatus designed for detecting signals of or from an array can be employed in the present method. Such an apparatus or method can detect one or more of the detectable labels described hereinbelow. For example, known and commercially available apparatus can detect colorimetric, fluorescent, or like detectable signals of an array. Surface plasmon resonance can be employed to detect binding of a disclosed probes and arrays to the array. The methods and systems for detecting a signal from a feature or location of an array can be employed for monitoring or scanning the array for any binding that occurs and results in a detectable signal. Monitoring or detecting can include viewing (e.g., visual inspection) of the array by a person.

The present disclosed probes and arrays or compositions can be provided in any variety of common formats. The present nucleotide or composition can be provided in a container, for example, as a solid (e.g., a lyophilized solid) or a liquid. In some embodiments, each of a plurality of disclosed probes and arrays is provided in its own container (e.g., vial, tube, or well). The present disclosed probes and arrays or compositions can be provided with materials for creating a nucleic acid array or with a complete nucleic acid array. In fact, the present polynucleotide or composition can be provided bound to one or more features of a nucleic acid array.

### Oligonucleotide Quantification

In some embodiments, signals from the features corresponding to the reference oligonucleotides can be used to construct a dose response curve (i.e. calibration curve) to estimate the relationship between signal and the amount of test oligonucleiotide in a sample.

In some embodiments, a level of binding of the labeled small RNA to a subject nucleic acid probe is assessed. The term “level of binding” means any assessment of binding (e.g. a quantitative assessment) usually done, as is known in the art, by detecting signal (i.e., pixel brightness) from the label associated with the labeled nucleic acids. Since the level of binding of labeled nucleic acid to a subject nucleic acid probe is proportional to the level of bound label, the level of binding of labeled nucleic acid is usually determined by assessing the amount of label associated with the feature.

In some embodiments, the methods described herein provide a signal proportional to the concentration of the analyte over a range of analyte concentrations. Within the linear range, s=sₒ+aC, where s is the observed signal, s₀ is constant background signal, C is the amount of input analyte, and a is the sensitivity of the assay. The linear dynamic range of the assay is the range of input concentrations for which the reported background-subtracted signal, (s−sₒ), is directly proportional to the input concentration. A plot of log(s−sₒ) vs log(C) will have a slope of 1.0 and an intercept of log(a).

In some embodiments, the present methods are characterized as providing a linear response for log(signal) vs log(input) when a reference oligonucleotide is analyzed throughout the range of between 0.01 amol to 10 fmol. The log(signal) vs log(input) curve can be analyzed using any suitable method, such as best linear fit. In some embodiments, the slope of the curve is 1.04±0.01.

In some embodiments, the present methods are characterized as providing a linear response for log(signal) vs log(input) when a reference oligonucleotide is analyzed throughout the range of between 0.2 amol to 2 fmol. In some embodiments, the slope of the curve is 1.04±0.01.

The background-subtracted fluorescence signal reported for each feature on an array can be quantitatively converted to an absolute number of labels (e.g., fluorophores) hybridized to that feature. Any suitable scanner may be used, and may be calibrated to report a selected number of counts/pixel for each dye molecule within that pixel. The number of pixels per feature can be selected by the design of the array.

The sample is usually labeled to make a population of labeled nucleic acids. In general, a sample may be labeled using methods that are well known in the art (e.g., using DNA ligase, terminal transferase, or by labeling the RNA backbone, etc.; see, e.g., Ausubel, et al., Short Protocols in Molecular Biology, 3rd ed., Wiley & Sons 1995 and Sambrook et al., Molecular Cloning: A Laboratory Manual, Third Edition, 2001 Cold Spring Harbor, N.Y.), and, accordingly, such methods do not need to be described here in great detail. In some embodiments, the sample is usually labeled with fluorescent label. In some embodiments, the labeling protocol can selected to introduce a known number of fluorophores per target oligonucleotide. In some embodiments, a labeling method that introduces exactly one fluorophore per target oligonucleotide may be used (see, e.g., Published U.S. Pat. Application No. 20060172317 and Wang et al. (2007) RNA 13:1-9). The number of hybridized target oligonucleotides can be obtained from the counts/pixel reported for a feature. The sum of background-subtracted counts/pixel for all features targeting a specific oligonucleotide yields the total number of hybridized targets. An example of this conversion is provided in the Examples below.

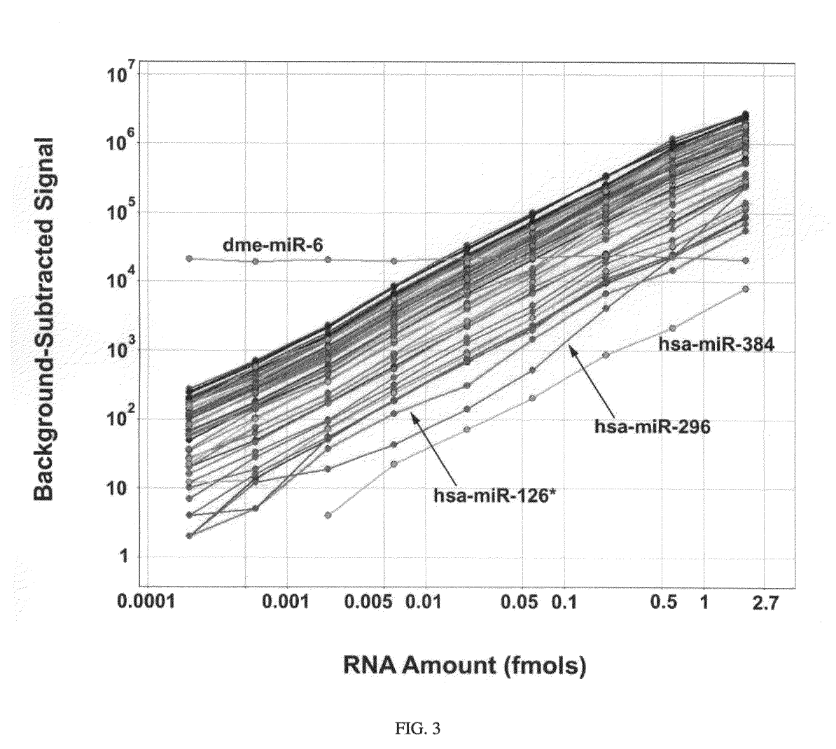

Any suitable method can be used to prepare a calibration curve. In some embodiments, a calibration curve can be generated as follows. A mixture of reference oligonucleotides is labeled and then successively diluted. Each diluted portion is hybridized to a separate array. As a non-limiting example, a set of reference oligonucleotides, including of each reference oligonucleotide (e.g., 2 fmol), is labeled, and diluted to a selected volume (e.g., 100 μL). A portion (e.g., 50 μL) of this mixture is transferred to another tube and diluted by a selected factor (e.g., up to a final volume of 100 μL for a factor of 2 dilution), and this process is continued to generate a plurality of sample mixtures continuing successively lower levels of the reference oligonucleotides (e.g., 1000, 500, 250, 125, 62.5, 31.25, 15.06, etc. amol of each reference oligonucleotide). Each mixture is then hybridized to a separate array. An example of this method is illustrated in FIG. 3, and in the Examples below.

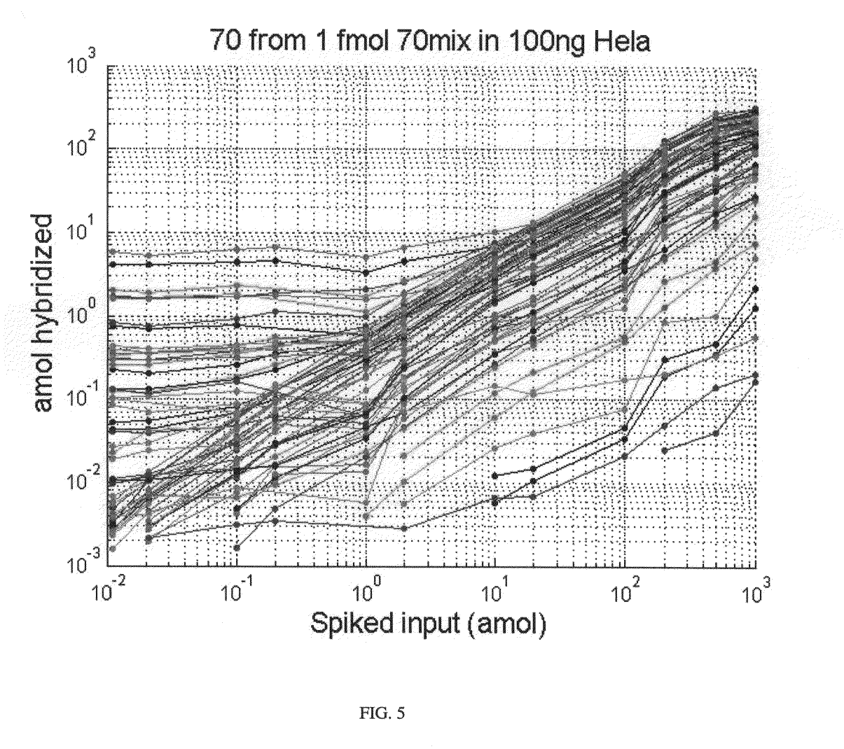

In some embodiments, a reference oligonucleotide can be added in a known amount to a sample (i.e., used as a spike-in), such as a fluid sample, and this spiked sample can then be labeled and hybridized to a calibration array as described herein. In some embodiments, a range of levels of a reference oligonucleotide can be added to different aliquots of sample, followed by labeling and hybridization to a series of different arrays. Non-limiting examples of such a range of levels are between about 0 to 5×, from 0 to 10×, from 0 to 100×, or from 0 to 1000× of the endogenous level of the test oligonucleotide. Such a range could be prepared by, e.g., serial dilution of the reference oligonucleotide. In some embodiments, a set of reference oligonucleotides can likewise be added in a known amount to a sample, labeled and hybridized, in order to obtain calibration data. Different levels of such a set can be employed with a series of different arrays as illustrated in FIG. 5. In general, the calibration curves become, or start to become, linear at the endogenous expression level of each miRNA, and are linear when the amount spiked is much greater than the endogenous level. In some embodiments, the spiked amount is at least 5× to 10× the endogenous amount. In some embodiments, the spiked amount ranges from zero to at least 10× to 100× of the highest endogenous expression level expected in the sample. As an example of preparing a calibration curve by serial dilution, a number (e.g., 10) aliquots are taken from a test sample, each aliquot containing an equal amount (e.g., 100 ng) of total RNA. To each aliquot, a different amount of the unlabeled reference oligonucleotide mixture is added (e.g., such that 0, 0.1, 0.3, 1, 3, 10, 30, 100, 300, 1000 amol of each reference sequence). Then each of these differentially spiked total RNA samples is separately labeled and hybridized to a separate array.

The present methods are characterized in that signals measured for aliquots from labeling reactions, measured on separate arrays, such as, for example, on different test arrays, or on a test array and a calibration array, agree within about 10%.

### Detectable Labels

The present disclosed probes, arrays or targets can include a detectable label. Suitable labels include radioactive labels and non-radioactive labels, directly detectable and indirectly detectable labels, and the like. Directly detectable labels provide a directly detectable signal without interaction with one or more additional chemical agents. Examples of directly detectable labels include calorimetric labels, fluorescent labels, and the like. Indirectly detectable labels interact with one or more additional members to provide a detectable signal. Suitable indirect labels include a ligand for a labeled antibody and the like.

Suitable fluorescent labels include, for example, any of the variety of fluorescent labels disclosed in United States Patent Application Publication No. 20010009762. Specific suitable fluorescent labels include: xanthene dyes, e.g., fluorescein and rhodamine dyes, such as fluorescein isothiocyanate (FITC), 6-carboxyfluorescein (commonly known by the abbreviations FAM and F), 6-carboxy-2′,4′,7′,4,7-hexachlorofluorescein (HEX), 6-carboxy-4′,5′-dichloro-2′,7′-dimethoxyfluorescein (JOE or J), N,N,N′,N′-tetramethyl-6-carboxyrhodamine (TAMRA or T), 6-carboxy-X-rhodamine (ROX or R), 5-carboxyrhodamine-6G (R6G⁵ or G⁵), 6-carboxyrhodamine-6G (R6G⁶ or G⁶), and rhodamine 110; cyanine dyes, e.g., Cy3, Cy5 and Cy7 dyes; alexa dyes, e.g., alexa fluor 555, alexa fluor 594;coumarins, e.g., umbelliferone; benzimide dyes, e.g., Hoechst 33258; phenanthridine dyes, e.g., Texas Red; ethidium dyes; acridine dyes; carbazole dyes; phenoxazine dyes; porphyrin dyes; polymethine dyes, e.g., cyanine dyes such as Cy3, Cy5, etc; BODIPY dyes and quinoline dyes.

### Methods of Making Probes and Probe Compositions

The presently disclosed probes and arrays can be produced by known methods. For example, the disclosed probes and arrays can be made by known methods for chemical synthesis. Chemical synthesis can employ commercial synthesizers. Chemical synthesis can produce thousands or more different sequences in multi-well plates. The method can include synthesizing segments of the polynucleotide and ligating the segments to form the polynucleotide. Chemical synthesis can be employed to make a transcript or fragment thereof.

The disclosed probes and arrays can be made by known recombinant methods. For example, conventional cloning and subcloning techniques and PCR can be employed to produce the disclosed probes and arrays. In some embodiments, targets or fragments such as exons can be isolated from biological samples by PCR.

### Arrays

In some embodiments, the disclosed probes can be integrated into diagnostic devices, for example an array. The device can be interrogated with a sample to detect the presence or amount of one or more target in the sample. The target or amount of target can then be correlated with a phenotype, for example, propensity to develop a pathology such as cancer. The presence, absence, or quantity of a detected or undetected target or combination of targets can be indicative of a phenotype of the source organism of the sample. More particularly, the disclosed devices can be used to detect one or more targets present in a fluid sample including, but not limited to blood, serum, plasma, saliva, sweat, tears, mucous, stool, lymphatic fluid, semen, interstitial fluid, gastric fluid, spinal fluid, or a particular cell, cell type, a plurality of cell types, organism or individual, species, genus, order, or the like. For example, the probes can detect the presence or expression level of a gene or gene transcript or a polypeptide. The target can be found in a particular cell, microorganisms, virus, plant, fungus, eukaryote, prokaryote, or other organism.

In some embodiments, the disclosed probes and arrays can be diagnostic of a particular growth condition, environmental condition, developmental stage, or the like. For example, the disclosed probes and arrays can be diagnostic of a gene of interest, in particular a miRNA gene of interest, in a particular developmental stage of an organism such as an insect larvae, seed, plant, or vertebrate fetus, typically a non-human vertebrate fetus.

In some embodiments, arrays on a substrate can be designed for testing against any type of sample, whether a trial sample, reference sample, a combination of them, or a known mixture of polynucleotides (in which latter case the arrays may be composed of features carrying unknown sequences to be evaluated). Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 50 cm², 20 cm², or even less than 10 cm², or less than 1 cm². For example, features may have widths (that is, diameter, for a round spot) in the range from a 10 μm to 1.0 cm. In some embodiments each feature may have a width in the range of 1.0 μm to 1.0 mm, of 5.0 μm to 500 μm, or of 10 μm to 200 μm. Non-round features may have area ranges equivalent to that of circular features with the foregoing width (diameter) ranges. Feature sizes can be adjusted as desired, for example by using one or a desired number of pulses from a pulse jet to provide the desired final spot size.

Substrates of the arrays can be any solid support, a colloid, gel or suspension. Exemplary solid supports include, but are not limited to metal, metal alloys, glass, natural polymers, non-natural polymers, plastic, elastomers, thermoplastics, pins, beads, fibers, membranes, or combinations thereof.

At least some, or all, of the features are of different compositions (for example, when any repeats of each feature composition are excluded the remaining features may account for at least 5%, 10%, or 20% of the total number of features), each feature typically being of a homogeneous composition within the feature. Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, photolithographic array fabrication processes are used. It will be appreciated though, that the interfeature areas, when present, could be of various sizes and configurations.

Array features will generally be arranged in a regular pattern (for example, rows and columns). However other arrangements of the features can be used where the user has, or is provided with, some means (for example, through an array identifier on the array substrate) of being able to ascertain at least information on the array layout (for example, any one or more of feature composition, location, size, performance characteristics in terms of significance in variations of binding patterns with different samples, or the like). Each array feature is generally of a homogeneous composition.

Each array may cover an area of less than 100 cm², or even less than 50 cm², 10 cm², or 1 cm². In some embodiments, the substrate carrying the one or more arrays will be shaped generally as a rectangular solid (although other shapes are possible), having a length of more than 4 mm and less than 1 m, for example, more than 4 mm and less than 600 mm, less than 400 mm, or less than 100 mm; a width of more than 4 mm and less than 1 m, for example, less than 500 mm, less than 400 mm, less than 100 mm, or 50 mm; and a thickness of more than 0.01 mm and less than 5.0 mm, for example, more than 0.1 mm and less than 2 mm, or more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse jets of either polynucleotide precursor units (such as monomers) in the case of in situ fabrication, or the previously obtained polynucleotide. Such methods are described in detail in, for example, U.S. Pat. Nos. 6,656,740; 6,458,583; 6,323,043; 6,372,483; 6,242,266; 6,232,072; 6,180,351; 6,171,797; or 6,323,043; or in U.S. patent application Ser. No. 09/302,898 (now abandoned), and the references cited therein. These references are incorporated herein by reference. Other drop deposition methods can also be used for fabrication. Also, instead of drop deposition methods, known photolithographic array fabrication (e.g., as available from Affymetrix), or micromirror fabrication methods (e.g., as available from Roche) may be used. Interfeature areas need not be present particularly when the arrays are made by photolithographic methods as described in those patents. In some embodiments, a subject nucleic acid probe is a “surface-bound nucleic acid probe”, where such a nucleic acid probe is bound, usually covalently but in some embodiments non-covalently, to a surface of a solid substrate, i.e., a sheet, bead, or other structure. In some embodiments, a surface-bound nucleic acid probe may be immobilized on a surface of a planar support, e.g., as part of an array.

In some embodiments, an array may contain a plurality of features (i.e., 2 or more, about 5 or more, about 10 or more, about 15 or more, about 20 or more, about 30 or more, about 50 or more, about 100 or more, about 200 or more, about 500 or more, about 1000 or more, usually up to about 10,000 or about 20,000 or more features, etc.), each containing a different nucleic acid probe for detecting a small RNA. As few as one and as many as all of the nucleic acid probes of a subject array may contain a Tₘ enhancement domain. In some embodiments, at least 5%, at least 10% or at least 20% of the nucleic acid probes of an array contain a Tₘ enhancement domain.

Different nucleic acid probes are present in different features of an array, i.e., spatially addressable areas of an array. In some embodiments a single type of nucleic acid probe is present in each feature (i.e., all the nucleic acid probes in the feature have the same sequence). However, in some embodiments, the nucleic acids in a feature may be a mixture of nucleic acids having different sequences.

In some embodiments, an array may contain a single nucleic acid probe. However, in some embodiments, a subject array may contain a plurality of subject nucleic acid probes that correspond to (i.e., may be used to detect) a corresponding plurality of polynucleotides. In some embodiments, the subject arrays may contain nucleic acid probes for detecting at least a portion all of the identified small RNAs of a particular organism.

In general, methods for the preparation of nucleic acid arrays, particularly oligonucleotide arrays, are well known in the art (see, e.g., Harrington et al. (2000) Curr Opin Microbiol. 3:285-91, and Lipshutz et al. (1999) Nat Genet. 21:20-4) and need not be described in any great detail. The subject nucleic acid arrays can be fabricated using any means available, including drop deposition from pulse jets or from fluid-filled tips, etc, or using photolithographic means. Either polynucleotide precursor units (such as nucleotide monomers), in the case of in situ fabrication, or previously synthesized polynucleotides can be deposited. Such methods are described in detail in, for example U.S. Pat. Nos. 6,242,266, 6,232,072, 6,180,351, 6,171,797, 6,323,043, etc., the disclosures of which are herein incorporated by reference.

### Methods Employing Arrays

Following receipt by a user of an array made by an apparatus or method of the present disclosure, it will typically be exposed to a sample (for example, a fluorescently labeled polynucleotide or protein containing sample) in any well known manner and the array is then read. Reading of the array may be accomplished by illuminating the array and reading the location and intensity of resulting fluorescence at multiple regions on each feature of the array. For example, a scanner may be used for this purpose which is similar to the AGILENT MICROARRAY SCANNER manufactured by Agilent Technologies, Santa Clara, Calif. Other suitable apparatus and methods are described in U.S. Pat. Nos. 6,592,036; 6,583,424; 6,486,457; 6,406,849; 6,371,370; 6,355,921; 6,320,196; 6,251,685; 6,222,664; and 7,018,842. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. Nos. 6,251,685, or 6,221,583 and elsewhere). Data from read arrays may be processed in any know manner, such as described in U.S. Pat. Nos. 6,591,196 and 6,768,820, and many commercially available array feature extraction software packages. A result obtained from the reading of an array may be used in that form or may be further processed to generate a result such as that obtained by forming conclusions based on the pattern read from the array (such as whether or not a particular target sequence may have been present in the sample, or whether or not a pattern indicates a particular condition of an organism from which the sample came). A result of the reading (whether further processed or not) may be forwarded (such as by communication) to a remote location if desired, and received there for further use (such as further processing).

In some embodiments the array can be read using Matrix Assisted Laser Desorption Ionization Time-of-flight Mass Spectrometry (MALDI).

### Methods for Preparing Mixtures of Reference Oligonucleotides

The reference oligonucleotides described above and throughout this specification may be prepared using any suitable method, such as, for example, the known, phosphotriester and phosphite triester methods, or automated embodiments thereof. In one such automated embodiment, dialkyl phosphoramidites are used as starting materials and may be synthesized as described by Beaucage et al. Tetrahedron Letters (1981) 22:1859.

In some embodiments, methods of producing pluralities or sets of reference oligonucleotides comprise array-based methods, wherein a nucleic acid array is employed as a source of the mixture of reference oligonucleotides. Methods for synthesizing oligonucleotides on a modified solid support are described, e.g., in U.S. Pat. No. 4,458,066; U.S. patent application Ser. Nos. 11/831,771 and 11/284,495; and Published U.S. Application Nos. 20070037175 and 20070059692.

In some embodiments, nucleic acids comprising reference oligonucleotide sequences are synthesized on a surface of a substrate, such as a flat substrate, which may be textured or treated to increase surface area. The substrate may comprise a membrane, sheet, rod, tube, cylinder, bead or other structure. In some embodiments, the substrate comprises a non-porous medium, such as a planar glass substrate. The surface of the substrate typically has, or can be chemically modified to have, reactive groups suitable for attaching organic molecules. Examples of such substrates include, but are not limited to, glass, silica, silicon, plastic, (e.g., polypropylene, polystyrene, Teflon™, polyethylimine, nylon, polyester), polyacrylamide, fiberglass, nitrocellulose, cellulose acetate, or other suitable materials. The substrate may be treated in such a way as to enhance the attachment of nucleic acid molecules. For example, a glass substrate may be treated with polylysine or silane to facilitate attachment of nucleic acid molecules. Silanization of glass surfaces for oligonucleotide applications has been described (see, Halliwell et al. (2001) Anal. Chem. 73:2476-2483). In some embodiments, the surface of the substrate to which nucleic acid molecules are attached bears chemically reactive groups, such as carboxyl, amino, hydroxyl and the like (e.g., Si—OH functionalities, such as are found on silica surfaces).

In some embodiments, an array of nucleic acids comprising reference oligonucleotide sequences is subjected to cleavage conditions sufficient to cleave or separate the surface immobilized nucleic acids of the features of the array from the solid support to produce a product composition of solution phase reference oligonucleotide molecules, e.g., by action of a cleavage agent, as elaborated further below.

In some embodiments, an array employed to generate a mixture of reference oligonucleotides comprises a substrate having a planar surface on which is immobilized a plurality of distinct chemical features of surface immobilized nucleic acids. In some embodiments, surface immobilized single stranded nucleic acids are bound to the substrate surface by a cleavable linkage (i.e., are releasable).

In some embodiments, the surface immobilized single-stranded nucleic acids are characterized by including: (a) a variable domain (comprising a reference oligonucleotide sequence); and (b) a cleavable domain, where the cleavable domain includes a region (e.g., site or sequence) that is cleavable, e.g., such that the cleavable domain serves as a cleavable linker; where the variable domain can be separated from the array surface by the cleavable domain. The cleavable domain may or may not be a constant domain, as desired. In some embodiments, the cleavable domain will be the same or identical for all of the surface-immobilized nucleic acids of the array.

In some embodiments, there are provided arrays that comprise a plurality of single-stranded nucleic acid features each comprising reference oligonucleotide sequences immobilized on a surface of substrate via a cleavable linker. In some embodiments, the surface immobilized reference oligonucleotide sequences are described by the formula:

surface−L−V

wherein:

L is a cleavable domain having a cleavable region; and

V is a variable domain;

where each immobilized single-stranded nucleic acid may be oriented with its 3′ or 5′ end proximal to the substrate surface and the variable domain V differs between features. The variable domain comprises a reference oligonucleotide sequence as described herein.

As mentioned above, in addition to the variable domain, at least some of the surface immobilized nucleic acids present on the array includes a cleavable domain having a cleavable region. In some embodiments, cleavable linker molecules are attached to a substrate and a nucleic acid molecule is then synthesized at the end of the linker. Reference oligonucleotide molecules can be harvested from an array substrate by any useful means. In some embodiments, following provision of an array, a next step is to cleave the surface immobilized nucleic acid sequences of the array features from the solid support to produce a solution phase mixture of reference oligonucleotides. In this step, the array is subjected to cleavage conditions sufficient to cleave the immobilized nucleic acids of the features from the substrate surface. Generally, this step comprises contacting the array with an effective amount of a cleavage agent. The cleavage agent will, necessarily, be chosen in view of the particular nature of the cleavable region of the cleavable domain that is to be cleaved, such that the region is labile with respect to the chosen cleavage agent as described herein.

The cleavable region of the cleavable domain may be cleavable by a number of different mechanisms. In some embodiments, the cleavable domain, and particularly the cleavable region thereof, may be cleaved by light, i.e. photocleavable, chemically cleavable, or enzymatically cleavable. Photocleavable or photolabile moieties that may be incorporated into the constant domain may include, but are not limited to: o-nitroarylmethine and arylaroylmethine, as well as derivatives thereof, and the like (see, e.g., Published U.S. Patent Application Nos. 20040152905 and 20040259146).

For chemically cleavable moieties, the array can be contacted with a chemical capable of cleaving the linker, e.g. the appropriate acid or base, depending on the nature of the chemically labile moiety. Suitable cleavable sites include, but are not limited to, the following: base-cleavable sites such as esters, particularly succinates (cleavable by, for example, ammonia or trimethylamine), quaternary ammonium salts (cleavable by, for example, diisopropylamine) and urethanes (cleavable by aqueous sodium hydroxide); acid-cleavable sites such as benzyl alcohol derivatives (cleavable using trifluoroacetic acid), teicoplanin aglycone (cleavable by trifluoroacetic acid followed by base), acetals and thioacetals (also cleavable by trifluoroacetic acid), thioethers (cleavable, for example, by HF or cresol) and sulfonyls (cleavable by trifluoromethane sulfonic acid, trifluoroacetic acid, thioanisole, or the like); nucleophile-cleavable sites such as phthalamide (cleavable by substituted hydrazines), esters (cleavable by, for example, aluminum trichloride); and Weinreb amide (cleavable by lithium aluminum hydride); and other types of chemically cleavable sites, including phosphorothioate (cleavable by silver or mercuric ions) and diisopropyldialkoxysilyl (cleavable by fluoride ions). Some embodiments of chemically cleavable moieties that may be incorporated into the cleavable domain may include, but are not limited to: dialkoxysilane, P-cyano ether, amino carbamate, dithoacetal, disulfide, 3′-(S)-phosphorothioate, 5′-(S)-phosphorothioate, 3′-(N)-phosphoramidate, 5′-(N)-phosphoramidate, and ribose. Other cleavable sites will be apparent to those skilled in the art or are described in the pertinent literature and texts (see, e.g., Brown (1997) Contemporary Organic Synthesis 4(3):216-237; U.S. Pat. Nos. 5,700,642 and 5,830,655).

In some embodiments, a cleavable domain comprises a nucleotide cleavable by an enzyme such as nucleases, glycosylases, among others. A wide range of polynucleotide bases may be removed by DNA glycosylases, which cleaves the N-glycosylic bond between the base and deoxyribose, thus leaving an abasic site (see, e.g., Krokan et. al. (1997) Biochem. J. 325:1-16). The abasic site in a polynucleotide may then be cleaved by Endonuclease IV, leaving a free 3′-OH end. Suitable DNA glycosylases may include uracil-DNA glycosylases, G/T(U) mismatch DNA glycosylases, alkylbase-DNA glycosylases, 5-methylcytosine DNA glycosylases, adenine-specific mismatch-DNA glycosylases, oxidized pyrimidine-specific DNA glycosylases, oxidized purine-specific DNA glycosylases, EndoVIII, EndoIX, hydroxymethyl DNA glycosylases, formyluracil-DNA glycosylases, pyrimidine-dimer DNA glycosylases, among others. Cleavable base analogs are readily available synthetically. In some embodiments, a uracil may be synthetically incorporated in a polynucletide to replace a thymine, where the uracil is the cleavage site and site-specifically removed by treatment with uracil DNA glycosylase (see, e.g., Kunkel, T. A. (1985) Proc. Natl. Acad. Sci. USA 82:488-492; Lindahl (1990) Mutat. Res. 238:305-311; Published U.S. Patent Application No. 20050208538). The uracil DNA glycosylases may be from viral or plant sources, and is available commercially (e.g., Invitrogen, Catalog no. 18054-015). The abasic site on the polynucleotide strand may then be cleaved by E. coli Endonuclease IV.

In some embodiments, to release the reference oligonucleotide molecules the entire substrate can be treated with cleavage agent, or alternatively, a cleavage agent can be applied to a portion of the substrate.

In some embodiments, a silica containing solid support having nucleic acids comprising reference oligonucleotide sequences immobilized on a surface thereof is subjected to cleavage conditions such that a fluid cleavage product which includes nucleic acids and silica is produced (see, e.g., Published U.S. patent application Ser. No. 11/284,495). The resultant fluid cleavage product can then purified to produce a final nucleic acid composition that includes a substantially reduced amount of silica, as compared to the fluid cleavage product.

Ammonium hydroxide can be used to harvest synthesized nucleic acid molecules from a substrate, even if the synthesized nucleic acid molecules are not attached to the substrate by a chemical bond that is cleavable using ammonium hydroxide. While not wishing to be bound by theory, the ammonium hydroxide may etch or scrape the substrate to release the synthesized nucleic acid molecules therefrom. In embodiments comprising a photocleavable linker, the linker can be cleaved by exposure to light of appropriate wavelength, such as for example, ultra violet light, to harvest the nucleic acid molecules from the substrate (see, e.g., J. Olejnik and K. Rothschild (1998) Methods Enzymol 291:135-154).

A chemical cleavage agent as described above can be contacted with the substrate for a period of time sufficient for the nucleic acids to be released from the surface of the support. Cleavage conditions can be determined empirically. In some embodiments contact is maintained for a period of time ranging from about 0.5 h to about 144 h, such as from about 2 h to about 120 h, and including from about 4 h to about 72 h. Any convenient method may be used to contact the cleavage agent with the nucleic acid displaying substrate. For instance, contacting may include, but is not limited to: submerging, flooding, rinsing, spraying, etc. Contact may be carried out at any convenient temperature, where in representative embodiments contact is carried out at temperatures ranging from about 0 C° to about 60 C°, including from about 20 C° to about 40 C°, such as from about 20 C° to about 30 C°.

The resultant fluid cleavage product can be purified to obtain a purified composition of solution phase reference oligonucleotide molecules.

In some embodiments, a cleavable linker phosphoramidite can be added to the 5′-terminal OH end of a support-bound oligonucleotide to introduce a cleavable linkage. Multiple nucleic acids of the same or different sequence, linked end-to-end in tandem, can be synthesized by further incorporation of cleavable building block, and nucleic acid synthesis prior to cleavage from the substrate (see, e.g., Pon et al. (2005) Nucleic Acids Res. 33:1940-1948; U.S. Published Patent Application Nos. 20030036066 and 20030129593).

### Computer Related Embodiments

In some embodiments, the methods include a step of transmitting data or results from at least one of the detection, calibration, or analysis, as described herein, to a remote location. By “remote location” is meant a location other than the location at which the array is present and hybridization occur. For example, a remote location could be another location (e.g. office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart.

“Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation or use. Any convenient telecommunications means may be employed for transmitting the data, e.g., facsimile, modem, internet, etc.

The disclosure also provides a variety of computer-related embodiments. Specifically, the methods of designing a set of nucleic acid probes for use in an array to analyze small RNAs in a sample may be performed using a computer. Accordingly, in some embodiments, there are provided a computer-based systems for designing a set of nucleic acid probes using the above methods. Other computer based methods may include calculating and storing calibration data from the analysis of reference oligonucleotides, calculating the level of a target oligonucleotide in a sample from the calibration data, storing or outputting the signal data and the calculated results.

In some embodiments, the methods are coded onto a computer-readable medium in the form of “programming”, where the term “computer readable medium” as used herein refers to any storage or transmission medium that participates in providing instructions or data to a computer for execution or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer.

With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware or software combination which will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

### Kits

Also provided herein are kits for practicing the subject methods, as described above. The subject kits contain at least a subject nucleic acid probe. The kits may include one or more of: a reference oligonucleotide, a test array, a calibration array, and calibration data as described herein. The nucleic acid probe may be bound to the surface of a solid support and may be present in an array. The kit may also contain reagents for isolating small RNAs from a cell, reagents for labeling a small RNA, reagents for hybridizing labeled small RNAs to an array, a control small RNA, etc. The various components of the kit may be present in separate containers or certain compatible components may be precombined into a single container, as desired.

In addition to the above-mentioned components, the subject kits may further include instructions for using the components of the kit to practice the subject methods, i.e., instructions for sample analysis and other information such as calibration information. The instructions and information for practicing the subject methods may be recorded on a suitable recording medium. For example, these may be printed on a substrate, such as paper or plastic, etc. As such, the instructions and other information may be present in the kits as a package insert, in the labeling of the container of the kit or components thereof (i.e., associated with the packaging or subpackaging) etc. In some embodiments, the instructions and other information are present as an electronic storage data file present on a suitable computer readable storage medium, e.g., CD-ROM, diskette, etc. In some embodiments, the actual instructions and other information are not present in the kit, but means for obtaining them from a remote source, e.g., via the internet, are provided. An example of these embodiments is a kit that includes a web address where the instructions and other information can be viewed or from which they can be downloaded. As with the instructions and other information, this web address is recorded on a suitable substrate.

### Utility

The subject methods and kits may be employed in a variety of diagnostic, drug discovery, and research applications that include, but are not limited to, diagnosis or monitoring of a disease or condition (where the expression of a particular small RNA is a marker for the disease or condition), discovery of drug targets (where the small RNA is differentially expressed in a disease or condition and may be targeted for drug therapy), drug screening (where the effects of a drug are monitored by assessing the level of a small RNA), determining drug susceptibility (where drug susceptibility is associated with a particular profile of small RNAs) and basic research (where is it desirable to identify the presence of small RNAs in a sample, or, in some embodiments, the relative levels of a particular small RNA in two or more samples).

In some embodiments, relative levels of small RNAs in two or more different small RNA samples may be obtained using the above methods, and compared. In these embodiments, the results obtained from the above-described methods are usually normalized to the total amount of RNA in the sample or to control RNAs (e.g., constitutive RNAs), and compared. This may be done by comparing ratios, or by any other means. In some embodiments, the small RNA profiles of two or more different samples may be compared to identify small RNA that are associated with a particular disease or condition (e.g., a small RNA that that is induced by the disease or condition and therefore may be part of a signal transduction pathway implicated in that disease or condition).

In some embodiments, the different samples may consist of an “experimental” sample, i.e., a sample of interest, and a “control” sample to which the experimental sample may be compared. In some embodiments, the different samples are pairs of cell types or fractions thereof, one cell type being a cell type of interest, e.g., an abnormal cell, and the other a control, e.g., normal, cell. If two fractions of cells are compared, the fractions are usually the same fraction from each of the two cells. In some embodiments, however, two fractions of the same cell may be compared. Exemplary cell type pairs include, for example, cells isolated from a tissue biopsy (e.g., from a tissue having a disease such as colon, breast, prostate, lung, skin cancer, or infected with a pathogen etc.) and normal cells from the same tissue, usually from the same patient; cells grown in tissue culture that are immortal (e.g., cells with a proliferative mutation or an immortalizing transgene), infected with a pathogen, or treated (e.g., with environmental or chemical agents such as peptides, hormones, altered temperature, growth condition, physical stress, cellular transformation, etc.), and a normal cell (e.g., a cell that is otherwise identical to the experimental cell except that it is not immortal, infected, or treated, etc.); a cell isolated from a mammal with a cancer, a disease, a geriatric mammal, or a mammal exposed to a condition, and a cell from a mammal of the same species, preferably from the same family, that is healthy or young; and differentiated cells and non-differentiated cells from the same mammal (e.g., one cell being the progenitor of the other in a mammal, for example). In some embodiments, cells of different types, e.g., neuronal and non-neuronal cells, or cells of different status (e.g., before and after a stimulus on the cells) may be employed. In some embodiments of the methods, the experimental material is cells susceptible to infection by a pathogen such as a virus, e.g., human immunodeficiency virus (HIV), etc., and the control material is cells resistant to infection by the pathogen. In some embodiments, the sample pair is represented by undifferentiated cells, e.g., stem cells, and differentiated cells.

Cells from yeast, plants and animals, such as fish, birds, reptiles, amphibians and mammals may be used in the subject methods. In some embodiments, mammalian cells, i.e., cells from mice, rabbits, primates, or humans, or cultured derivatives thereof, may be used.

Accordingly, among other things, the instant methods may be used to link the expression of certain genes to certain physiological events.

In some embodiments a subject array is employed to assess a sample of small RNAs that is prepared from a cell. Methods for preparing small RNAs from cells are well known in the art (see, e.g., Lagos-Quintana et al. (2001) Science 294:853-858; Grad et al. (2003) Mol Cell 11:1253-1263; Mourelatos et al. (2002) Genes Dev 16:720-728; Lagos-Quintana et al. (2002) Curr Biol 12:735-739; Lagos-Quintana et al. (2003) RNA 9:175-179 and other references cited above).

In some embodiments, a set of reference oligonucleotides as described herein can be used as a standard for measurement calibration. The signals obtained using such a set can be used to calibrate the absolute or relative quantity of the set or of another set of reference oligonucleotides, or of unknown target oligonucleotides in a sample. The set of reference oligonucleotides can also be added to a sample, as described above. The signals of the sample with and without the added set of reference oligonucleotides can be evaluated for calibration or quantification of overall or specific target oligonucletoides molecules.

### EXAMPLES

The following examples serve to more fully describe the manner of using the above-described disclosure. It is understood that these examples in no way serve to limit the true scope of this disclosure, but rather are presented for illustrative purposes.

### Example 1

### Probe Design and Specificity

In some embodiments, in a microarray hybridization, conditions are equally stringent for all targets measured. When designing probes, the melting temperatures (Tₘ) of the various probe-target hybrids can be equalized. The small size of miRNAs requires a different strategy than that used for genomic or mRNA targets, where sequences with equal melting temperatures can be selected. Probes efficient for miRNA analysis were designed using only unmodified DNA oligonucleotides by utilizing several design features. First, a G was added to the 5′ end of each probe sequence to complement the 3′ cytosine introduced in labeling. This added G-C pair stabilizes the targeted miRNA relative to homologous RNAs. With the additional G-C interaction, nearly all mature miRNAs have calculated melting temperatures above 55° C. under the hybridization conditions used in the present Examples. Those miRNAs whose melting temperatures exceed 57.5° C. are destabilized by reducing the hybridization length of the probes, starting from the 5′ end of the miRNA sequence. Since most of the sequence homology among miRNAs tends to be near the 5′ end (Griffiths-Jones 2004; Griffiths-Jones et al. 2006), sequentially eliminating base pairing from the 5′ end has little effect on probe sequence specificity. To help distinguish the targeted miRNA from unintended potential targets, a hairpin structure was incorporated onto the 5′ end of the probe, directly abutting the 3′ end of the hybridizing sequence. The hairpin destabilizes hybridization to larger nontarget RNAs, and can provide additional stabilization if the target-probe duplex stacks with the probe hairpin. The final step in the probe design strategy was empirical selection of the optimal probe length. For each miRNA sequence, all probe sequences with a calculated Tₘ (SantaLucia et al. 1996) between 50° C. and 60° C. were synthesized on microarrays both with and without the 5′ hairpin. The microarrays were then hybridized with synthetic and tissue RNAs at 50° C., 52.5° C., 55° C., 57.5° C., 60° C., and 65° C. The two sequences observed to melt just below and just above 57.5° C. were included in subsequent array designs. The data presented here were obtained from an experimental microarray containing 2-12 probes for each of the 314 human miRNAs listed in version 7.0 of the Sanger miRNA database (microma.sanger.ac.uk; Griffiths-Jones 2004; Griffiths-Jones et al. 2006).

### Example 2

### Materials and Methods

### RNA Sources

Synthetic miRNAs were obtained from Dharmacon and Ambion. Total RNAs from human heart, skeletal muscle, breast, brain, thymus, liver, and placenta were from Ambion. Frozen and FFPE breast tumor total RNAs were from Michael Bittner (Translational Genomics Research Institute). Size fractionation total RNA samples were size fractionated using the Ambion Flash-PAGE system according to the manufacturer's protocol or by using denaturing 20% polyacrylamide gels.

### RNA Labeling and Hybridization

All enzymes were from Amersham, and reactions were performed with supplied buffer and BSA, unless otherwise specified. All enzymes are as described by the manufacturer. The pCp-Cy5 and pCp-Cy3 were made by conjugating Cy5 or Cy3 (Amersham) to the 3′ phosphate of pCp (Dharmacon). Labeling efficiency was optimized with 20 pmol synthetic miRNAs using T4 RNA ligase, 1 nmol pCp-Cy5 or pCp-Cy3 and 0%, 15%, 25%, or 30% (v/v) DMSO (Sigma) in 10 μL, which was then labeled with ³²P using T4 polynucleotide kinase, analyzed on a denaturing 20% polyacrylamide gel, and quantitated by PhosphorImager (Molecular Dynamics). For miRNA profiling, 120 ng of tissue total RNA, 60 ng of fractionated tissue RNA, or 120 ng of preserved tumor RNA were dephosphorylated with 16 units calf intestine alkaline phosphatase for 30 min at 37° C. The reaction was terminated at 100° C. for 5 min and immediately cooled to 0° C. Seven microliters of DMSO were then added and heated to 100° C. for 3 min and immediately cooled to 0° C. Ligase buffer and BSA were added and ligation was performed with 50 mM pCp-Cy5 or pCp-Cy3 and 15 units T4 RNA ligase in 28 μL at 16° C. overnight. The labeled miRNAs were desalted with MicroBioSpin6 columns (BioRad) and combined with 4.5 mg of random DNA 25-mers (Operon). Some 22.5 μL 2× hybridization buffer (Agilent) was added to the labeled mixture to a final volume of 45 μL. The mixture was heated for 5 min at 100° C. and immediately cooled to 0° C. Each 45 μL sample was hybridized onto a microarray at 55° C. for 20-48 h. Time course experiments showed that hybridization is essentially complete after 40 h (data not shown). Slides were washed 10 min in 6×SSC/0.005% Triton X-102, then for 5 min in 0.1×SSC/0.005% Triton X-102, both at room temperature. Slides were scanned on an Agilent microarray scanner (model G2565A) at 100% and 5% sensitivity settings. Agilent Feature Extraction software version 8.1 was used for image analysis.

### Probe and Microarray Design

Custom microarrays were manufactured by Agilent Technologies (Hughes et al. (2001) Nat. Biotechnol. 19:342-347). Each slide contained eight individual microarrays, each with 1900 features. Arrays included 48 negative control features, used to estimate fluorescence background and background variance. Approximately 1400 features targeted 314 human miRNAs and five Drosophila miRNAs. Each miRNA was targeted by 2-12 array features containing probes of varying lengths, half of which contained the hairpin loops. The 3′ end of each probe was spaced away from the array surface with a T₁₀ stilt. Exemplary suitable microarrays are available commercially (see, e.g., Human miRNA Microarray Kit (V2) from Agilent Technologies, Santa Clara, Calif.).

### Tₘ Determination

All probe lengths whose calculated DNA-DNA duplex Tₘ (SantaLucia et al. (1996) Biochemistry, 35:3555-3562) lay between 50° C. and 60° C. were synthesized on screening arrays. Probes for miRNAs whose full-length sequence had low calculated Tₘ (<50° C.) were designed for both the full-length sequence (including the ligated 39° C.) and the sequence shortened by one base (from 5′ end). The actual Tₘ of the candidate probes were determined by hybridization of various tissue samples and synthetic miRNAs at temperatures between 50° C. and 65° C. Probes observed to melt between 55° C. and 57.5° C. were included in subsequent array designs.

Probe Selection from Empirical Melting Curves

The melting temperature depends on the enthalpy (ΔH) and entropy (ΔS) of hybridization and on the probe concentration. The ΔH and ΔS in turn depend on the length and sequence of the complementary region of the probe, and can be adjusted by adjusting the probe length. The probe concentration on the arrays studied is approximately 10 pM per complementary feature, and can be adjusted by varying the number of features targeting each miRNA.

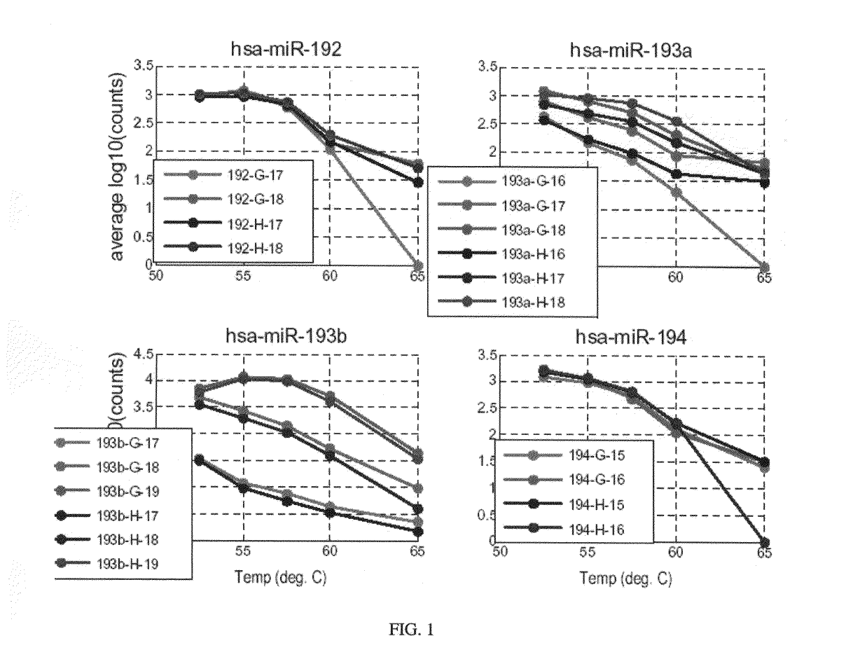

After preliminary screening of all probe lengths whose calculated DNA-DNA duplex Tₘ (SantaLucia et al. (1996)) lay between 50° C. and 60° C., one to six different length probes observed to melt near 55° C. were synthesized on the test arrays. In some cases (e.g. miR-384) the calculated Tₘ of the full-length sequence was less than 50° C.; in these cases the full length sequence was included and the sequence shortened by one base. RNAs from six different tissue samples and from a mixture of 57 synthetic miRNAs were hybridized for 41 hours at 50, 52.5, 55, 57.5, 60, and 65° C. The background-subtracted signals of probes targeting each miRNA were averaged across all samples, to compute an average response for each probe at each temperature. The Tₘ of the miRNA was estimated from a plot of log 10(response) as a function of hybridization temperature. Representative melting curves are shown in FIG. 1 which shows representative miRNA melting curves. Each curve shows the background subtracted signal for a single probe targeting the miRNA, averaged across seven samples. Probe names indicate probe length and presence (‘—H—’) or absence (‘-G-’) of a 5′ hairpin.

Based on a simple homogeneous model of duplex dissociation, it was expected that the observed signal would be independent of temperature at temperatures well below the Tₘ, and to be log linear with temperature at temperatures well above the Tₘ. This expectation is sometimes complicated by a slow increase in signal at lower temperatures, which may be attributed to cross-hybridization with unintended targets. A typical miRNA probe reports a relatively constant signal up to a certain temperature, and a significantly lower signal at the next higher temperature. The target-probe hybrid is then considered to melt between these temperatures. For example, all four probes targeting hsa-miR-192 appear to melt between 57.5 and 60° C. The estimation of the melting temperature from these plots is necessarily somewhat subjective, but estimations by different researchers using the same data set agreed in almost all cases to within 2.5° C., which is approximately the temperature precision of the hybridization ovens used in the present Examples. 269 of the 314 miRNAs targeted on the array reported an average response sufficiently above background (average background-subtracted signal for the eight samples were greater than 100 counts at 55° C.) that an empirical melting temperature could be determined. Empirically determined Tₘ's usually, but not always, agreed with the calculated Tₘ's within ±3° C.; many of the exceptions were probes to miRNAs containing unusual sequence motif (e.g. miR-296) or prone to secondary structure. Within the ±3° C. range, there was little concordance between calculated and observed Tₘ's. Alternative Tₘ-estimation parameterizations, including RNA-RNA parameterizations, did not yield consistently more accurate predictions. An optimal probe length for the present assay is one which melts at a temperature just above that of the standard protocol (55° C.). The fraction of targets hybridized at equilibrium (the hybridization yield) is then between 50% and about 90%. Choosing longer probes, with higher Tₘ, would increase the hybridization yield, but at the cost of decreased specificity. To allow for uncertainty in the Tₘ measurement, both the longest probe which appeared to melt between 55 and 57.5° C., and the shortest probe unmelted at 57.5° C. were selected for subsequent array designs. Thus for miR-193b, shown above, the subsequent, “Tₘ-matched” array included the 18-mer and 19-mer probes, but not the 17-mer.

### Example 3

### Quantitative Measurements

### Dynamic Range

An analytical measurement can report a signal proportional to the concentration of the analyte over a range of analyte concentrations. Within the linear range, s=sₒ+aC, where s is the observed signal, sₒ is a constant background signal, C is the amount of input analyte, and a is the sensitivity of the assay. The linear dynamic range of the assay is the range of input concentrations for which the reported background-subtracted signal, (s−sₒ), is directly proportional to the input concentration. A plot of log(s−sₒ) vs log(C) will have a slope of 1.0 and an intercept of log(a). For each of the 57 synthetic miRNAs shown in FIG. 3, the best linear fit of the log(signal) to log(input) curves was determined.

In FIG. 3, an equimolar mixture of 57 synthetic miRNAs was labeled and hybridized in 0.2 amol to 2 fmol aliquots on nine individual microarrays. Prelabeled 0.2 fmol of dme-miR-6 was added as a control. All miRNAs behaved similarly, except for the three indicated. Both miR-126* and miR-384 had exceptionally low calculated Tₘ. The unusual sequence content of miR-296 inhibits hybridization at low concentrations, resulting in a nonlinear response. The slopes of the linear portions of the curves for all miRNAs are 1.04 6 0.01 (1 SD). Data are background subtracted signals, not normalized, summed over all probes to each miRNA. The list of miRNAs (see Griffiths-Jones (2004) Nucleic Acids Res. 32:D109-D111; Griffiths-Jones et al. (2006) Nucleic Acids Res. 34:D140-D144; microrna.sanger.ac.uk) used to generate the figure are included in Table 1.

TABLE 1

miRNA
hsa-let-7a
hsa-let-7b
hsa-let-7c
hsa-let-7d
hsa-let-7e
hsa-let-7f
hsa-let-7g
hsa-let-7i
hsa-miR-101
hsa-miR-108
hsa-miR-126*
hsa-miR-134
hsa-miR-135a
hsa-miR-136
hsa-miR-144
hsa-miR-146a
hsa-miR-146b
hsa-miR-147
hsa-miR-185
hsa-miR-187
hsa-miR-188
hsa-miR-190
hsa-miR-191
hsa-miR-196a
hsa-miR-196b
hsa-miR-198
hsa-miR-19b
hsa-miR-200a
hsa-miR-208
hsa-miR-20a
hsa-miR-20b
hsa-miR-211
hsa-miR-212
hsa-miR-214
hsa-miR-23b
hsa-miR-296
hsa-miR-301
hsa-miR-302c*
hsa-miR-30a-3p
hsa-miR-30e-3p
hsa-miR-30e-5p
hsa-miR-328
hsa-miR-33
hsa-miR-335
hsa-miR-34c
hsa-miR-370
hsa-miR-373
hsa-miR-373*
hsa-miR-374
hsa-miR-375
hsa-miR-376b
hsa-miR-377
hsa-miR-384
hsa-miR-423
hsa-miR-425
hsa-miR-494
hsa-miR-98

The slopes are 1.04±0.01, consistent with a linear response throughout the range of miRNA inputs studied (0.2 amol to 2 fmol). The lower bound of the dynamic range is set by the detection limit, which is 0.1 amol or lower for most of the miRNAs. The upper bound is set by the surface probe density, which limits the maximum number of targets that can hybridize. The absence of significant curvature in the titration curves even at the highest input concentrations suggests that the upper bound is at least 10 fmol input. The dynamic range of the assay thus exceeds five orders of magnitude, of which at least four orders of magnitude are linear. The minimal deviations from linearity observed in the titration curves of FIG. 3 give an indication of the reproducibility of hybridization and wash on multiple arrays, as labeling variation was obviated. Signals measured for aliquots from pooled labeling reactions, measured on different arrays, generally agreed within 10%.

### Calculation of Yields

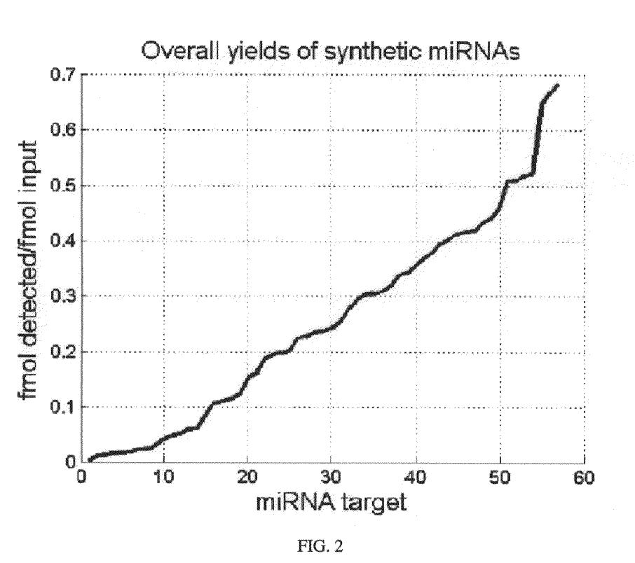

The background-subtracted fluorescence signal reported for each feature on the array can be quantitatively converted to an absolute number of fluorophores hybridized to that feature. The Agilent scanner is calibrated to report 0.5±0.1 counts/pixel for each Cy-3 or Cy-5 molecule within that pixel (when set to 100% sensitivity and scanned at 10 μm pixel resolution). Since each feature on the arrays discussed in this Example comprises 115 pixels, and the labeling protocol introduces exactly one fluorophore per target miRNA, each count/pixel reported for a feature represents 230 targets hybridized to that feature. The sum of background-subtracted counts/pixel for all features targeting a specific miRNA yields the total number of hybridized targets. The overall yield for each miRNA is the fraction of the original targets which are detected. The yield can be computed by dividing the measured sensitivity (counts/fmol_input), determined from the intercepts of the regression lines as described above, by the scanner calibration (counts/fmol_hybridized). For example, the titration curve for miRNA-134 (the top curve in FIG. 3) has an intercept of 6.252, corresponding to a sensitivity of 10^{6.252}=1.79×10⁶ counts/fmol_input, summed over the six features targeting miRNA-134. This signal represents (1.79×10⁶)(230)/6×10⁸=0.68 fmol of hybridized target, a 68% yield. The estimated yields of the 57 synthetic miRNAs, sorted by yield, are shown in FIG. 2. The amount of miRNA in total RNA samples can be similarly estimated. For example, the total background-subtracted signal from the four let-7a probes in the 120 ng breast tissue sample was 2.34×10⁵ counts, or 0.09 fmol of hybridized target. The overall labeling and hybridization yield for let-7a in the oligonucleotide mixture was 32%, so a reasonable estimate of the amount of let-7a in 120 ng of the breast tissue RNA is 0.09/0.32=0.27 fmol (2 pg). The signals from all the targeted miRNAs collectively was 5.5×10⁶ counts (15 pg hybridized) in the breast sample. In some embodiments, a probe design strategy would strive for hybridization yields between about 50% and 80%. A probe which melts at precisely 55° C. would be 50% hybridized at equilibrium, and one melting at 57.5° C. would be about 75-80% hybridized (ΔS-290 to -425 cal/mol/K) at equilibrium. Since the hybridization proceeds nearly to equilibrium within a 40 hour hybridization time (data not shown), it was expected that a probe melting within the designed temperature range (55-57.5° C.) to have a hybridization yield of between 50 and 80%. Raising the yield by increasing the probe-target stability is undesirable, since it reduces binding specificity. On the other hand, yields below 20% are also undesirable, because they compromise detection limits and are harder to calibrate reliably. The overall yield, as shown in FIG. 2, is the product of the labeling yield and the hybridization yield. Seventeen oligonucleotides, including those with low probe Tₘ or predicted secondary structure, show overall yields below 10% on the experimental arrays used for this study. Three, with high probe Tₘs, show yields over 60%. The majority have yields within the expected range.

The detection limit for the assay cannot be directly determined from the titration curves of FIG. 3, because nearly all miRNAs are still within their linear response range at the lowest input amount tested. However, the detection limit can be estimated from the background noise level; a target concentration which reports a signal greater than three times the background noise is deemed to be detectable. The background noise in the system is dominated by residual fluorescence of the DNA probes and was estimated from the signals reported by non-hybridizing negative control probes. A background noise of 1-5 counts/pixel for microarrays hybridized at 55° C. was typically observed. Thus, a reported background subtracted signal of 3-15 counts/pixel is a reasonable estimate of the detection limit of a miRNA targeted by a single probe. If a particular miRNA is targeted by several array features, it is considered to have been detected if the total signal from all the features exceeds 3× the total background noise. The total background noise for the sum of N features is sqrt(N) times the noise from one feature. On the arrays used in these experiments, each miRNA is targeted by 2-12 different features, and therefore must report a total signal of at least 5-50 counts (depending on the noise level of the array and the number of features targeting the miRNA) to be detectable. The upper bound on the detection limit corresponds to 0.02 amol of hybridized target. The detection limit for miRNA input is actually higher than this, because not all input oligonucleotides are labeled and not all labeled targets are hybridized. The average labeling and hybridization yield observed for the 57 synthetic miRNAs as tested was about 25%. From these considerations it was estimated that the detection limit for most miRNAs to be 0.1 amol or lower. Detection limits can also depend on cross-hybridization of probes to unintended targets. For highly homologous targets, such as the members of the let-7 family, the detection limit of one member of the family in the presence of a high abundance of homologues can be limited by cross-hybridization to undesired targets, rather than by residual fluorescence. Homologous miRNAs exhibiting significant cross-hybridization are relatively few, and it is prefered to treat them as special cases, amenable to correction in data analysis based on calibration studies. The level of background observed, both from residual fluorescence and from cross-hybridization, can be assessed from the 55° C. oligonucleotide-mix results.

### Example 4

### Hybridization with Extended Input Range

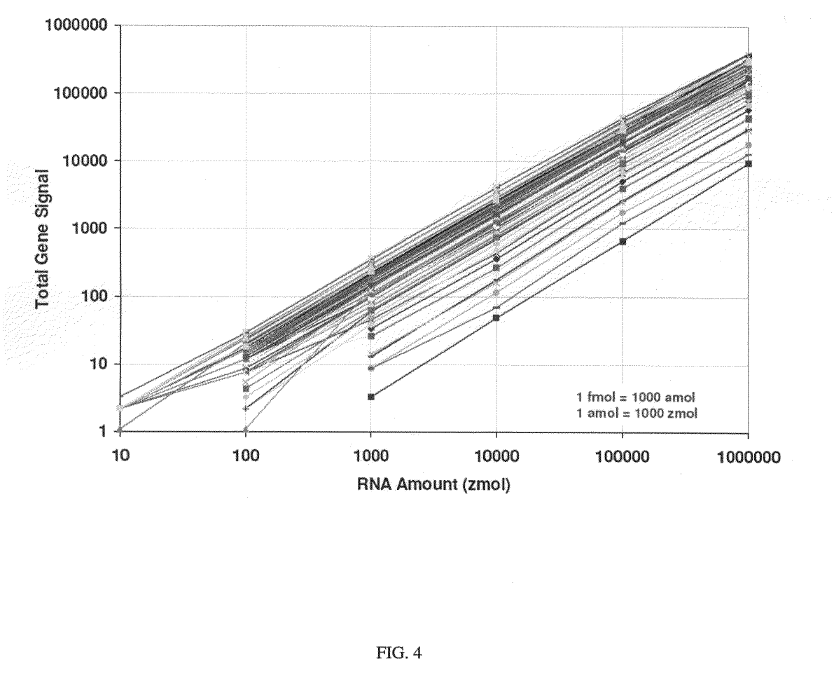

A set of 67 synthetic miRNAs were labeled and hybridized as described in the above Examples, but with an input range of 0.01 amol to 1 fmol/miRNA per microarray (FIG. 4). (10 zmol equals approximately 6000 molecules.) The array included single-color hybridization, probes selected by empirical melting temperature determination, hairpin-probes only, and multiple features per probe sequence. The list of miRNAs used to generate FIG. 4 are included in Table 2.

TABLE 2

hsa-miR-33
hsa-miR-98
hsa-miR-101
hsa-miR-134
hsa-miR-136
hsa-miR-138
hsa-miR-144
hsa-miR-147
hsa-miR-185
hsa-miR-187
hsa-miR-188
hsa-miR-190
hsa-miR-191
hsa-miR-198
hsa-miR-208
hsa-miR-211
hsa-miR-212
hsa-miR-296
hsa-miR-301
hsa-miR-328
hsa-miR-335
hsa-miR-370
hsa-miR-373
hsa-miR-374
hsa-miR-375
hsa-miR-377
hsa-miR-423
hsa-miR-450
hsa-miR-126*
hsa-miR-130a
hsa-miR-135a
hsa-miR-142-5p
hsa-miR-146a
hsa-miR-146b
hsa-miR-18a
hsa-miR-18b
hsa-miR-196a
hsa-miR-196b
hsa-miR-19a
hsa-miR-19b
hsa-miR-200a
hsa-miR-20a
hsa-miR-20b
hsa-miR-23a
hsa-miR-23b
hsa-miR-27a
hsa-miR-27b
hsa-miR-29c
hsa-miR-302c*
hsa-miR-30a-3p
hsa-miR-30e-3p
hsa-miR-30e-5p
hsa-miR-34c
hsa-miR-369-3p
hsa-miR-373*
hsa-miR-376a
hsa-miR-376b
hsa-miR-517a
hsa-miR-517b
hsa-miR-520c
hsa-miR-520f
hsa-let-7d
hsa-let-7e
hsa-let-7f
hsa-let-7g
hsa-let-7i
hsa-miR-425-3p

### Example 5

### Titrating a Sample with Reference miRNA Oligonucleotides

FIG. 5 illustrates additions of a set of 70 different synthetic miRNA oligonucleotides to total RNA from HeLa cells. The curves flatten out at the endogenous expression level of each miRNA, and are linear when the amount spiked is much greater than the endogenous level. Each array was subjected to a separate labeling reaction.

The disclosed subject matter has been described with reference to various embodiments and techniques. However, it should be understood that many variations and modifications may be made while remaining within the spirit and scope of the disclosure.

What is claimed is:

1. A method for determining the level of a target oligonucleotide suspected of being present in a sample, the method comprising the steps of:
measuring hybridization of said target oligonucleotide to a test microarray;
measuring hybridization of a known amount of a reference oligonucleotide to a calibration microarray, wherein said reference oligonucleotide comprises the same sequence as said target oligonucleotide, wherein said test array and said calibration array comprise a probe capable of forming a duplex with said target oligonucleotide;
determining the level of said target oligonucleotide in said sample by comparing said hybridization of said target oligonucleotide with the hybridization of said reference oligonucleotide.

2. The nucleic acid probe of claim 1, wherein said target oligonucleotide is a small RNA selected from the group consisting of short interfering RNA (siRNA), microRNA (miRNA), tiny non-coding RNA (tncRNA), small modulatory RNA (smRNA), and combinations thereof.

3. The nucleic acid probe of claim 1, wherein said target oligonucleotide comprises miRNA.

4. The method of claim 1, wherein said test microarray and said calibration array are substantially identical with respect to their probes.

5. The method of claim 1, wherein said probe comprises consecutive nucleotides complementary to at least 12 consecutive nucleotides starting from about a 3′ end of an miRNA.

6. The method of claim 1, wherein said probe comprises a Tₘ enhancement domain that increases stability of said duplex.

7. The method of claim 6, wherein said test array comprises a plurality of different target-specific probes, wherein each target-specific probe has a melting temperature for its respective target oligonucleotide within about 5° C. of the other target-specific probes.

8. The method of claim 8, wherein the hybridization yield of each of the different probes with its respective target oligonucleotide is between about 50% and about 90%.

9. The method of claim 1, wherein said determining comprises calculating a conversion factor that directly converts a detected array signal to a quantity of said reference oligonucleotide.

10. The method of claim 1, wherein said array is fabricated by micromirror fabrication.

11. The method of claim 1, comprising:
a) labeling said target oligonucleotide;
b) subjecting said target oligonucleotide to hybridization conditions with said test microarray;
c) measuring a signal value for said target oligonucleotide bound to said test microarray;
d) labeling said reference oligonucleotide under conditions substantially identical to those of step (a);
e) subjecting said reference oligonucleotide to hybridization with said calibration microarray under conditions substantially identical to those of step (b);
f) measuring a signal value for said reference oligonucleotide bound to said calibration microarray;
g) determining a relationship between said signal value of said reference oligonucleotide and the amount of said reference oligonucleotide;
h) determining the level of said target oligonucleotide based on said relationship.

12. The method of claim 11, wherein each of a plurality of different levels of said reference oligonucleotide is subjected to labeling and to hybridization to a separate respective calibration array, and step (g) comprises constructing a calibration curve.

13. A method for determining the level of a target oligonucleotide suspected of being present in a sample, the method comprising the steps of:
measuring hybridization of said target oligonucleotide to a test microarray;
quantifying the level of said target oligonucleotide in said sample by using predetermined calibration data relating hybridization of a reference oligonucleotide to a calibration array, wherein said reference oligonucleotide comprises the same sequence as said target oligonucleotide, wherein said test array and said calibration array comprise a probe capable of forming a duplex with said target oligonucleotide.

14. The method of claim 13, wherein in said quantifying comprises using a predetermined conversion factor that converts a detected array signal to a quantity of said reference oligonucleotide.

15. A method for determining the level of target oligonucleotides suspected of being present in a sample, the method comprising:
a) providing a sample comprising a plurality of different target oligonucleotides;
b) labeling the plurality of different target oligonucleotides in said sample;
c) subjecting said target oligonucleotides to hybridization conditions with a test microarray, wherein said test microarray comprises probes complementary to said plurality of different target oligonucleotides;
d) measuring signal values for said different target oligonucleotides bound to said plurality of test microarray;
e) providing a set of different reference oligonucleotides, each different reference oligonucleotide in said set having the same sequence as a respective one of said different target oligonucleotides;
f) subjecting a plurality of different known amounts of said set of reference oligonucleotides to hybridization conditions with a respective one of a plurality of calibration microarrays for each of said different known amounts, wherein said test microarray and said calibration microarrays are substantially identical with respect to their probes;
g) measuring signal values for said different reference oligonucleotides bound to said plurality of calibration microarrays;
h) determining a relationship between said signal values of said different reference oligonucleotides and the known amounts of said different reference oligonucleotides;
j) determining the level of at least some of said different target oligonucleotides based on said relationship.

16. A method for determining the level of target oligonucleotides in a sample, the method comprising:
a) providing a sample comprising a plurality of different target oligonucleotides;
b) splitting said sample into different portions;
c) labeling a first plurality of said different portions;
d) subjecting each one of said first plurality to hybridization conditions with a respective one of a plurality of test microarrays, each test microarray comprising probes complementary to said plurality of different target oligonucleotides;
e) measuring signal values for said different target oligonucleotides bound to said plurality of test microarrays;
f) mixing a different known amount of a set of different reference oligonucleotides with each respective one of a second plurality of said different portions, each different reference oligonucleotide in said set having the same sequence as a one of said different target oligonucleotides;
g) subjecting each one of said second plurality to hybridization conditions with a respective one of a plurality of calibration microarrays, wherein said test microarrays and said calibration microarrays are substantially identical with respect to their probes;
h) measuring signal values for said different reference oligonucleotides bound to said plurality of calibration microarrays;
i) determining a relationship between said signal values of said different reference oligonucleotides and the known amount of said different reference oligonucleotides;
j) determining the level of at least some of said different target oligonucleotides based on said relationship.

17. A kit comprising:
a) a test microarray;
b) instructions for analyzing a target oligonucleotide using said test microarray, said instructions comprising calibration data for the hybridization of a reference oligonucleotide to a calibration microarray, wherein said test microarray and said calibration microarray have substantially identical probes, wherein said reference oligonucleotide comprises the same sequence as said target oligonucleotide.

18. The kit of claim 17, further comprising said reference oligonucleotide, wherein said reference oligonucleotide comprises an miRNA sequence.

19. The kit of claim 17, further comprising said calibration array.

20. The kit of claim 17, wherein said instructions comprise instructions for analyzing a plurality of different target oligonucleotides, and wherein said kit further comprises a set of different reference oligonucleotides, each different reference oligonucleotide in said set having the same sequence as one of said different target oligonucleotides.
